(19) United States
(12) Patent Application Publication
(10) Pub. No.: US 2011/0035671 A1
(43) Pub. Date: Feb. 10, 2011

(54) IMAGE PROCESSING DEVICE, METHOD OF SHARING VOICE OPERATION HISTORY, AND METHOD OF SHARING OPERATION ITEM DISTINGUISH TABLE

(75) Inventors: Hidetaka IWAI, Itami-shi (JP); Kazuo Inui, Itami-shi (JP); Nobuhiro Mishima, Yodogawa-ku (JP); Kaitaku Ozawa, Itami-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/842,159

(22) Filed: Jul. 23, 2010

(30) Foreign Application Priority Data
Aug. 6, 2009 (JP) 2009-183279

(51) Int. Cl. G06F 3/16; G06F 3/048

(52) U.S. Cl. 715/728; 715/810

(57) ABSTRACT

The present invention is intended to share information as to voice operation in an image processing device with a voice operation function with another image processing device, thereby improving operability for using another one. An image processing device allowed to be connected to a network comprising: an operational panel for displaying a menu screen and receiving a manual operation to the menu screen; a speech input part for inputting speech; an operation item specifying part for specifying an operation item to be a target of operation based on a voice word; a voice operation control part for executing a processing corresponding to the specified operation item; a history information generation part for generating a voice operation history information in which the voice word and the specified operation item are associated; and a transmission part for transmitting the generated voice operation history information to another image processing device through the network.

This application is based on the application No. 2009-183279 filed in Japan, the contents of which are hereby incorporated by reference.

### BACKGROUND OF THE INVENTION

1. Field of the Invention

The present invention relates to an image processing device, a method of sharing voice operation history, and a method of sharing operation item distinguish table. The present invention more specifically relates to a technique of sharing information concerning voice operation with a plurality of image processing devices.

2. Description of the Background Art

Image processing devices called as complex devices or MFPs (Multi Function Peripherals) generally include an operational panel. Some of those image processing devices stores therein setting operation as operation history information, when a user operates the operational panel manually to make various types of settings.

In such an image processing device, when a user logs in, operation history information corresponding to the user is obtained from a log management server through a network, and the operation history information is displayed on a display unit of the operational panel. This known technique is disclosed for example in Japanese Patent Application Laid-Open No. JP 2008-103903 A. In this conventional technique, if an operation to select from the operation history information displayed in a list form on the operational panel is made by the user, past setting of image processing mode recorded in the selected operation history information is applied to the present setting of image processing mode. So, when a plurality of image processing devices are connected to a network, for example, this conventional technique capable of sharing and using operation history of manual operation made in one of the image processing devices in another image processing device.

Furthermore, a variety of image processing devices with voice operation function are recently introduced. It is assumed, a voice word (key word) and each function that may be operated through the operational panel are associated with each other, for example. When the associated voice word is recognized by speech recognition, each function operable through the operational panel associated with the voice word to be displayed. This known technique is disclosed for example in Japanese Patent Application Laid-Open No. JP 2007-102012 A. In general, menu items of a menu screen displayed on the operational panel have a hierarchy structure. When setting operation of each function is made with manual operation, it is required to gradually transit to a menu item on lower level in response to the manual operation repeatedly made. For voice operation, a voice word is associated with a menu item on the lowest level, so the menu item on the lowest level may be set directly with menu items in the highest level being displayed on a top screen.

For an image processing device having an operational panel operable by speech input, a voice word desired by a user may also be registered in association with a menu item on the operational panel, for example. In this case, if the user makes speech input of the voice word registered in advance, he or she is allowed to make operation of desired settings without operating manually.

It is assumed a plurality of image processing devices are connected to the network, for example. Under the circumstance, desired voice word is registered only with a particular image processing device which is usually used by a user. In such case, when the user uses another image processing device, the voice word the user usually uses cannot be used for voice operation.

This problem is caused not only in case which another image processing device includes the voice operation function, but also in case which another image processing device does not include the voice operation function. By way of example, when using the image processing device which does not include the voice operation function, the user needs to find out a menu item on the lowest level normally set directly with voice operation by making operation on the operational panel manually. In many cases, it is difficult to know that the menu item on the lowest level operated directly with voice operation is positioned in a lower level of which menu item among the multiple menu items in the highest level displayed on the top screen. So, the efficiency in operability is extremely decreased.

### SUMMARY OF THE INVENTION

The present invention is intended to solve the problems described above. An object of the present invention is to allow information concerning voice operation used in an image processing device with a voice operation function to be shared with another image processing device, resulting in improvement in operability for using another image processing device.

First, the present invention is directed to an image processing device allowed to be connected to a network.

According to one aspect of the image processing device, the image processing device comprises: an operational panel for displaying a menu screen and receiving manual operation to the menu screen; a speech input part for inputting speech; an operation item specifying part for specifying an operation item to be a target of operation among menu items displayed on the menu screen based on a voice word input through the speech input part; a voice operation control part for executing a processing corresponding to the specified operation item; a history information generation part for generating a voice operation history information in which the voice word input through the speech input part and the operation item specified by the operation item specifying part are associated when the processing corresponding to the specified operation item is executed; and a transmission part for transmitting the voice operation history information generated by the history information generation part to another image processing device through the network.

According to another aspect of the image processing device, the image processing device comprises: an operational panel for displaying a menu screen and receiving manual operation on the menu screen; a speech input part for inputting speech; a storage part for storing an operation item distinguish table in which a voice word input through the speech input part and an operation item to be a target of operation of menu items displayed among the menu screen are associated; an operation item specifying part for specifying the operation item associated with the voice word input through the speech input part based on the operation item distinguish table; a voice operation control part for executing a processing corresponding to the operation item specified by the operation item specifying part; a table customization part for associating the voice word that a user desires with the menu item that is the operation item, and additionally registering in the operation item distinguish table, thereby updating the operation item distinguish table; and a transmission part for transmitting the operation item distinguish table updated by the table customization part to another image processing device through the network.

According to still another aspect of the image processing device, the image processing device comprises: an operational panel for displaying a menu screen and receiving a manual operation on the menu screen; an acquisition part for acquiring a voice operation history information through the network from another image processing device with a voice operation function for specifying an operation item to be a target of operation based on a voice word and receiving voice operation corresponding to the specified operation item; a voice operation history applying part for associating a menu item displayed on the menu screen and the voice word based on the voice operation history information acquired by the acquisition part; and a display control part for displaying the voice word associated by the voice operation history applying part on the operational panel.

Second, the present invention is directed to a method of sharing voice operation history.

According to an aspect of the method of sharing voice operation history, the method is for first image processing device with a voice operation function and second image processing device different from the first image processing device to share a voice operation history information in the first image processing device through a network. The method comprises the steps performed in the first image processing device of: (a) inputting a voice word; (b) specifying an operation item to be a target of operation among menu items displayed on a menu screen of an operational panel based on the input voice word; (c) executing a processing corresponding to the specified operation item; (d) generating a voice operation history information in which the voice word and the operation item are associated when the processing corresponding to the specified operation item is executed; and (e) transmitting the voice operation history information to the second image processing device through the network. The method comprises the steps performed in the second image processing device of: (f) acquiring the voice operation history information transmitted from the first image processing device through the network; (g) associating the voice word contained in the voice operation history information with the menu item displayed on a menu screen of an operational panel based on the acquired voice operation history information; and (h) displaying the voice word associated with the menu item on the operational panel.

Third, the present invention is directed to a method of sharing operation item distinguish table.

According to an aspect of the method of sharing operation item distinguish table, the method is for first image processing device with a voice operation function and second image processing device different from the first image processing device to share a voice operation history information in the first image processing device through a network. The method comprises the steps of: (a) associating the voice word that a user desires and the menu item that is the operation item, and additionally registering in the operation item distinguish table, thereby executing customization of the operation item distinguish table in the first image processing device; (b) transmitting the customized operation item distinguish table from the first image processing device to the second image processing device when customization of the operation item distinguish table is executed; and (c) using the operation item distinguish table received from the first image processing device for specifying the operation item based on the voice word input in the second image processing device.

### BRIEF DESCRIPTION OF THE DRAWINGS

FIG. 1 shows an exemplary configuration of an image processing system according to the first preferred embodiment;

FIG. 2 is a block diagram showing the hardware configuration of an image processing device with a voice operation function;

FIG. 3 shows an exemplary various types of information stored in a storage device of the image processing device with the voice operation function;

FIG. 4 shows the exemplary data structure of an operation history information DB;

FIG. 5 is a block diagram showing an exemplary configuration relating to the function of a controller in the image processing device with the voice operation function;

FIG. 6 is a block diagram showing the detailed configuration of a speech input processing part;

FIG. 7 is an exemplary structure of an operation item distinguish table;

FIGS. 8A, 8B, 8C and 8D are examples of each table contained in the operation item distinguish table;

FIGS. 9A and 9B are examples of manual operation history information and voice operation history information contained in the operation history information;

FIG. 10 shows an exemplary transmission processing of the voice operation history information executed by a shared information transmission part;

FIG. 11 is a block diagram showing an exemplary configuration in reference to functions realized by the controller of another image processing device;

FIG. 12 is a flow diagram explaining an exemplary procedure of a processing to update the voice operation history information in the image processing device with the voice operation function;

FIG. 13 is a flow diagram explaining an exemplary procedure of a processing to transmit the voice operation history information from the image processing device with the voice operation function to another image processing device;

FIG. 14 is a flow diagram explaining the process sequence of a function determination processing of the voice operation history information in another image processing device in detail;

FIG. 15 is a flow diagram explaining an exemplary procedure of a processing for executing operation using the received voice operation history information in the image processing device;

FIGS. 16A and 16B are examples of display screens displayed on a display unit of an operational panel;

FIG. 17 is a flow diagram explaining an another exemplary procedure of a processing for executing operation using the received voice operation history information in the image processing device;

FIGS. 18A and 18B are examples of other display screens displayed on the display unit of the operational panel;

FIG. 19 shows an exemplary configuration of the image processing system in the second preferred embodiment;

FIG. 20 is a block diagram showing the configuration of functions in the controller of the image processing device in the second preferred embodiment;

FIG. 21 is a flow diagram explaining an exemplary procedure of a transmission processing of the operation item distinguish table executed by the shared information transmission part;

FIG. 22 is a flow diagram explaining an exemplary procedure of a processing for updating the operation item distinguish table in the image processing device;

FIG. 23 is a flow diagram explaining an exemplary procedure of a customization processing in detail;

FIG. 24 is a flow diagram explaining an exemplary procedure of a processing to transmit the operation item distinguish table from the image processing device to another image processing device;

FIG. 25 is a flow diagram explaining an exemplary procedure of a process to specify an operation item corresponding to a voice word input in the image processing device; and

FIG. 26 is a flow diagram explaining the procedure of a processing for acquiring shared information, such as the voice operation history information and the operation item distinguish table by sending a request for transmission of the shared information to another image processing device.

### DESCRIPTION OF THE PREFERRED EMBODIMENTS

Preferred embodiments of the present invention are described in detail below with reference to figures. In the description given below, those elements which are shared in common among the preferred embodiments are represented by the same reference numerals, and these elements are not discussed repeatedly for the same description.

### First Preferred Embodiment

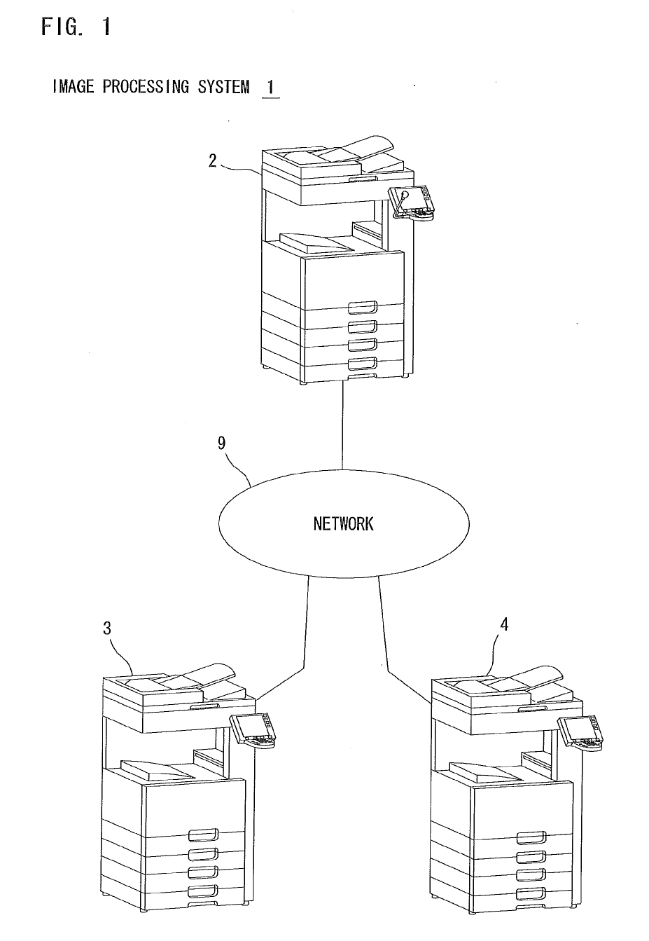

FIG. 1 shows an exemplary configuration of an image processing system 1 according to the first preferred embodiment. The image processing system 1 comprises a plurality of image processing devices 2, 3 and 4 connected to a network 9 including a local area network such as a LAN, an internet network and others. Each of the image processing devices 2, 3 and 4 is, for example, a device called as a complex device or a MFP (Multi Function Peripherals) with several functions including a copy function, a print function, a scan function and a FAX function. In the first preferred embodiment, the image processing device 2 of the plurality of the image processing devices 2, 3 and 4 includes a voice operation function, and other image processing devices 3 and 4 do not include the voice operation function. In FIG. 1, three image processing devices 2, 3 and 4 are connected to the network 9. However the number of image processing devices needs to be two or more but is not limited to three. Also, devices different from the image processing device (for instance, a personal computer, a server unit, or the like) may be connected to the network 9.

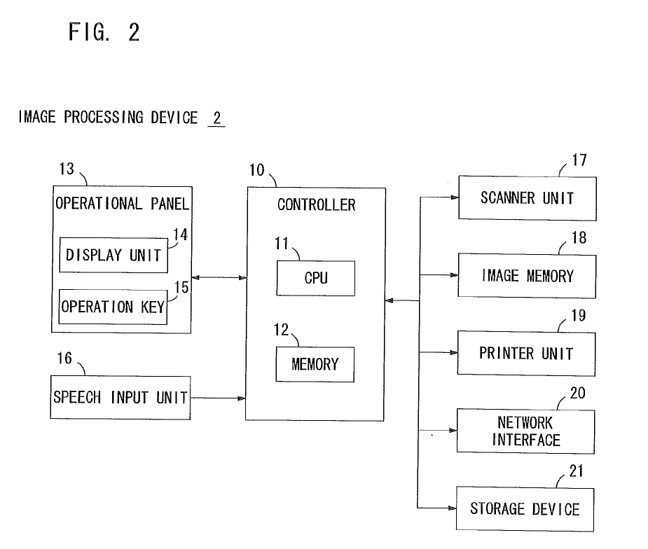

FIG. 2 is a block diagram showing the hardware configuration of the image processing device 2 with the voice operation function. As illustrated in FIG. 2, the image processing device 2 includes a controller 10, an operational panel 13, a speech input unit 16, a scanner unit 17, an image memory 18, a printer unit 19, a network interface 20 and a storage device 21.

The controller 10 includes a CPU 11 and a memory 12. The CPU 11 executes a predetermined program, thereby controlling each part of the image processing device 2. The memory 12 stores therein data such as temporary data and others for execution of the program by the CPU 11.

An operational panel 13 is operated by a user who uses the image processing device 2, and includes a display unit 14 on which various types of information is displayed to the user and an operation key 15 formed from, such as a plurality of touch panel keys arranged on a surface of the display unit 14 and a plurality of push-button keys arranged around the display unit 14. The operational panel 13 receives manual operation of the operation key 15 made by a user. If the operation key 15 is operated, the operational panel 13 outputs the information to the controller 10. A display screen displayed on the display unit 14 is controlled by the controller 10.

The speech input unit 16 for inputting speech is formed from a microphone or the like. Mode of voice operation is being ON in the image processing device 2, for example, the speech input unit 16 comes into operation to generate a speech signal corresponding to the input speech, and output the speech signal to the controller 10. The controller 10 then executes speech input processing based on the speech signal input from the speech input unit 16, and executes variety of processing according to a result of the processing as described herein below.

The scanner unit 17 generates image data (document data) by reading a document. The scanner unit 17 becomes operable when a job related to, for example, a copy function, a scan function or a FAX transmission function is executed. The scanner unit 17 reads a document placed thereon repeatedly, thereby generating image data. The scanner 17 processes image data generated by reading the document in accordance with the predetermined image processing. Such operation of the scanner 17 is controlled by the controller 10.

The image memory 18 temporarily holds therein an image data which is the subject of job execution. The image data generated by reading a document by the scanner unit 17 is stored, for example. The image memory 18 also holds therein an image data and others subject of printing input via the network interface 20.

The printer unit 19 forms an image to a printing medium such as an output sheet, and outputs the sheet in response to the image data. The printer unit 19 comes into operation to function when a job related to, for example, the copy function, the print function or the FAX receipt function is executed, thereby reading the image data hold in the image memory 18 and forming an image. This operation of the printer unit 19 is controlled by the controller 10.

The network interface 20 is a interface for connecting the image processing device 2 to the network 9. By way of example, for data transmission and receipt between the image processing device 2 and other image processing devices 3 and 4, the image processing device 2 transmits and receives data via this network interface 20. Moreover, the network interface 20 transmits and receives data with a computer and others connected to the network 9.

The storage device 21 is a nonvolatile storage such as a hard disk device. The storage device 21 stores therein the image data (document data) generated by the scanner unit 17, the image data (document data) input through the network interface 20, and others. Those data is allowed to be stored for a long time. As for example, a personal folder (memory region) set to be used by an individual user, and a shared folder set to be used with sharing by one or more users are established in advance in the storage device 21. So, document data subject of the storage is stored either of the personal folder or the shared folder or both of them depending on the objective of its use.

In addition, the storage device 21 stores therein in advance a plurality of destination addresses that are selectable when functions such as a scan transmission function and a FAX transmission function are used. When a function such as the scan transmission function and the FAX transmission function is selected, the image processing device 2 reads the destination addresses stored in the storage device 21, and displays the read destination addresses in a list form on the display unit 14 of the operational panel 13. So, the user operates to select a desired address from the destination addresses displayed in a list form, thereby designating an address to which the document data is transmitted.

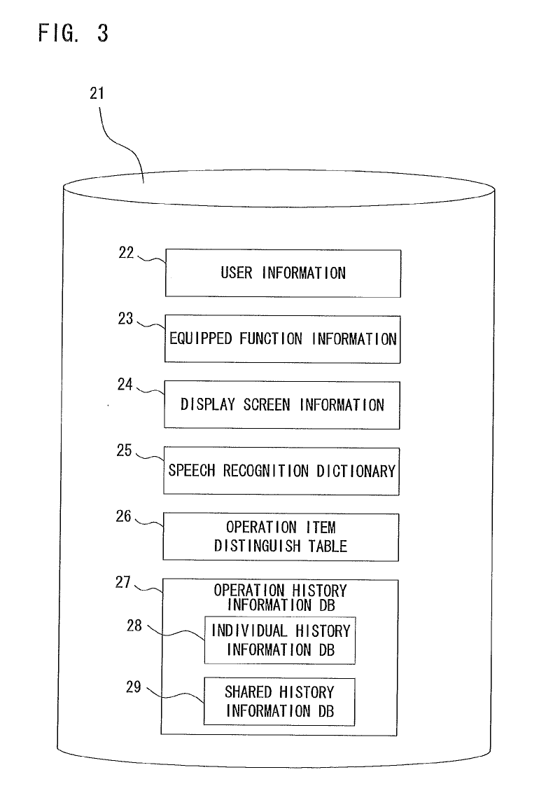

Moreover in the first preferred embodiment, the storage device 21 stores therein variety of information shown in FIG. 3 besides the document data or the destination addresses. When executing various operations, the controller 10 reads the variety of information shown in FIG. 3, and refers to the read information. Then, the controller 10 updates the information if necessary. Variety of information is explained in detail later.

As inputting information indicating the operation key 15 of the operational panel 13 was being operated manually, the controller 10 updates the display screen in response to the input information. So, for example, multiple menu items are shown on a menu screen displayed on the display unit 14, and each menu item has a hierarchy structure. More specifically, menu items on the highest level of the respective hierarchy structure are shown on a top screen, and multiple menu items are respectively included in a form of tree on the lower level of the menu items on the highest level. When a menu item on the highest level is selected and operated by the user, the controller 10 changes a screen to a menu screen for the user to select a menu item from multiple menu items on the level one level lower than the level that the menu items on the highest level position. This processing is repeatedly executed, and finally the user operates to select a menu item on the lowest level, that is a menu item with which setting is associated (from here, such menu item is sometimes called as “setting item”). In such case, the controller 10 switches the setting item corresponding to the selected menu item on the lowest level, for instance, from disabled status to enabled status. Therefore, as the user operates the operational panel 13 manually, the controller 10 executes processing corresponding to the manual operation, and applies the executed processing result to the image processing device 2. When the user gives an instruction on execution of a job by making manual operation, the controller 10 becomes operable to control each of the above-described parts, such as the scanner unit 17, the image memory 18, the printer unit 19, the network interface 20 and the storage device 21 as required, thereby executing the job specified by the user. There is a menu item besides the setting item, more specifically, the menu item that has another menu item on the lower level. As this menu item is selected, the screen is switched to a menu screen on which a menu item on the lower level is to be further selected. This type of menu item is sometimes called as “option item.”

As a speech signal is input from the speech input unit 16, the controller 10 identifies a menu item corresponding to the input speech signal, and updates the display screen of the display unit 14. The voice operation is made by speech by the user instead of manual operation made on the operational panel 13. It is assumed, for instance, that the screen on which the menu items on the highest level are shown on the display unit 14 and a target menu item is not shown on the top screen. Even in such case, as speaking corresponding to the menu item, the voice operation is capable of making the target menu item to be selected directly without menu items in the hierarchy structure to be selected sequentially like at manual operation. When the menu item selected with voice operation is the setting item, the controller 10 switches the setting corresponding to the menu item (setting item), for example, from disabled status to enabled status as well as the case for manual operation. When the menu item selected with voice operation is the option item, the controller 10 changes the display screen to a menu screen on which the menu item on the lower level than the selected menu item (option item) to be selected. Thus, when the user makes voice operation with speech input, the controller 10 executes processing corresponding to the voice operation, and applies the executed processing result to the image processing device 2. For the case the user gives an instruction for job execution by speaking, the controller 10 becomes operable to control the above-described parts, such as the scanner unit 17, the image memory 18, the printer unit 19, the network interface 20 and the storage device 21 as required, thereby executing the job specified by the user as well as the case for manual operation. The menu item shown on the display unit 14 to be operated with voice operation is described herein above. Alternatively, push-button keys arranged on the operational panel 13 and voice words are associated, respectively, thereby operating push-button keys with voice operation.

FIG. 2 shows the exemplary hardware configuration of the image processing device 2. The respective hardware configurations of the image processing devices 3 and 4 are the same as the one of FIG. 2 with the exception of the speech input part 16. So, in each of the image processing devices 3 and 4, only manual operation on the operational panel 13 is received as the input operation by the user.

FIG. 3 shows an exemplary various types of information stored in the storage device 21 of the image processing device 2. The storage device 21 stores therein a user information 21, a equipped function information 23, a display screen information 24, a speech recognition dictionary 25, an operation item distinguish table 26 and an operation history information database (hereinafter stated as “operation history information DB”) 27. The operation history information DB 27 still contains an individual history information database (hereinafter stated as “individual history information DB”) 28 and a shared history information database (hereinafter stated as “shared history information DB”) 29.

The user information 22 is information regarding a user registered in advance with the image processing device 2. In the user information 22, information regarding the user who is authorized to use the image processing device 2 is registered. This user information 22 is used for identifying the user who uses the image processing device 2. According to the first preferred embodiment, the user information 22 is referred to for execution of user authentication in the image processing device 2. It is assumed, for example, user ID, password and others entered by a user when he or she uses the image processing device 2 matches user ID and password registered in the user information 22. Then, the user may be identified as a user registered in the user information 22, and the authentication results in success. So, the user is allowed to use the image processing device 2. The user information 22 contains information as to a group of the user, that as to a workflow with which the user is registered, or the like besides information of user ID, password and others.

The equipped function information 23 is information indicating functions included in the image processing device 2. Information as to functions actually being available in the image processing device 2 among functions may be included as an optional extra is registered in the equipped function information 23 besides information as to functions included in the image processing device 2 as a standard.

The display screen information 24 is information in which a variety of screen information for displaying on the display unit 14 is recorded. As an example, information relating to menu screens having a respective hierarchy structures is registered. When updating the display screen of the display unit 14, the controller 10 updates the display screen based on this display screen information 24.

The speech recognition dictionary 25 is information of dictionary to be referred to by the controller 10 when the speech signal is input through the speech input part 16. The controller 10 identifies the voice word that the user said based on the input speech signal by referring to this speech recognition dictionary 25.

The operation item distinguish table 26 is a table for specifying a menu item or a push-button key corresponding to the identified voice word. More specifically, the operation item distinguish table 26 is a table for specifying an object of operation operated with voice operation (hereinafter stated as “operation item”), and in which the voice word and the operation item are associated. As identifying the voice word, the controller 10 specifies the operation item corresponding to the voice word input by the user by speech. The correspondence relation of a voice word and an operation item that the user desired is allowed to be registered in this operation item distinguish table 26.

The operation history information DB 27 records therein an operation history of the user. If, for instance, the user makes manual operation or voice operation to the image processing device 2, both of the individual history information DB 28 and the shared history information DB 29 are updated accordingly.

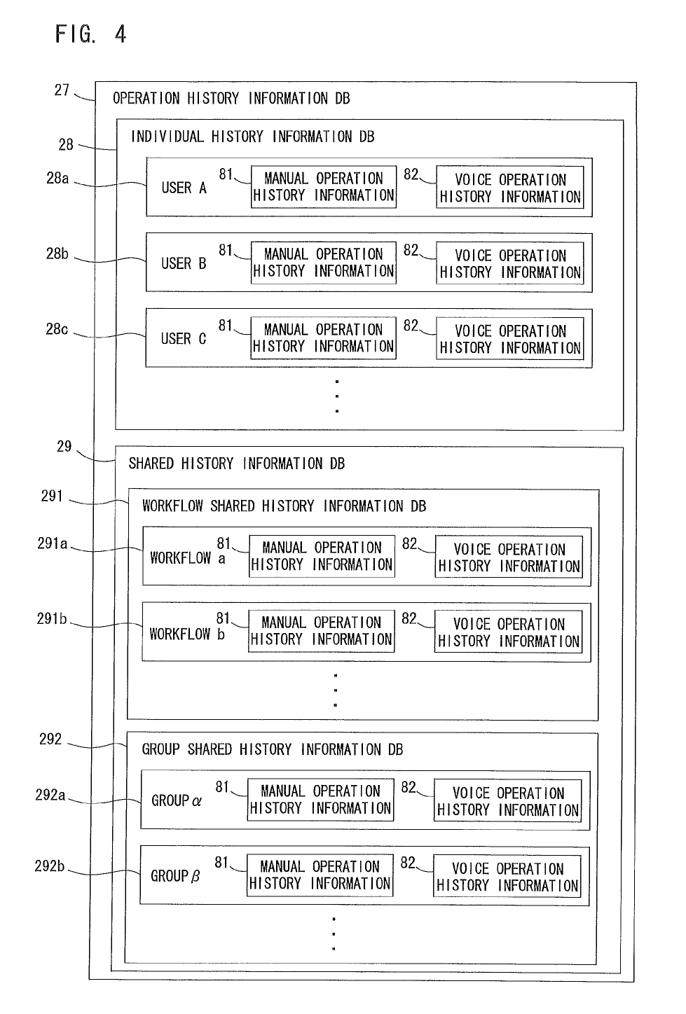

FIG. 4 shows the exemplary data structure of the operation history information DB 27. The individual history information DB 28 stores therein individual history information 28a, 28b and 28c provided for each user individually. The respective individual history information DB 28a, 28b and 28c of each user contains manual operation history information 81 and voice operation history information 82. The manual operation history information 81 is information in which manual operation history for manual operation of the operational panel 13 made by the respective user is recorded. The voice operation history information 82 is information in which voice operation history for voice operation made by the respective user through the speech input part 16 is recorded. In the individual history information DB 28, an individual user, the manual operation history information 81 recording a history of past manual operation made by the user, and the voice operation history information 82 recording a history of past voice operation made by the user are associated with each other and stored.

The shared history information DB 29 stores therein history information shared by one or more users. As illustrated in FIG. 4, the shared history information DB 29 contains a workflow shared history information database (hereinafter stated as “workflow shared history information DB”) 291 and a group history information database (hereinafter stated as “group shared history information DB”) 292.

The workflow shared history information DB 291 stores therein workflow shared history information 291a, 291b and others created at a level of one or more users who share a predetermined workflow, to be more specific, at a workflow level. The workflow in the first preferred embodiment means a sequence of a job executed through cooperation with the plurality of image processing devices 2, 3 and 4, for example. Also, the image processing device with which one or more users are set in advance is to be operated to execute a job of which the respective user is in charge, sequentially, thereby producing one output as a workflow at the end. Each of the workflow shared history information 291a, 291b and others contains the manual operation history information 81 and the voice operation history information 82. The manual operation history information 81 contained in the respective workflow shared history information 291a, 291b and others is information in which manual operation history for manual operation to the operational panel 13 made by individual user who shares the workflow is recorded. The voice operation history information 82 contained in the respective workflow shared history information 291a and 291b is information in which voice operation history for voice operation through the speech input part 16 made by individual user who shares the workflow is recorded. Thus, in the workflow shared history information DB 291, a workflow, the manual operation history information 81 recording a history of past manual operation made by the individual user who shares the workflow, and the voice operation history information 82 recording a history of past voice operation made by the individual user who shares the workflow are associated with each other and stored.

The group shared history information DB 292 stores therein group shared history information 292a, 292b and others created for each group to which the user belongs. Each of the group shared history information 292a and 292b contains the manual operation history information 81 and the voice operation history information 82 as well as the above-described workflow shared history information DB 291. The manual operation history information 81 contained in the respective group shared history information 292a and 292b is information in which manual operation history for manual operation to the operational panel 13 made by individual user involved in the group is recorded. The voice operation history information 82 contained in the respective group shared history information 292a and 292b is information in which voice operation history for voice operation through the speech input part 16 made by individual user belongs to the group is recorded. So, a group to which the individual user is belonged, the manual operation history information 81 recording a history of past manual operation made by the individual user belongs to the group, and the voice operation history information 82 recording a history of past voice operation made by the individual user belongs to the group are associated with each other and stored in the group shared history information DB 292.

By way of example, it is assumed that user A shares a workflow a, and belongs to a group α. If the user A operates the image processing device 2 manually, the history information is recorded to the manual operation history information 81 contained in each of the individual history information 28a of the user A, the workflow shared history information 291a of the workflow a, and the group shared history information 292a of the group α. If the user A operates the image processing device 2 by speech, the history information is recorded to the voice operation history information 82 contained in each of the individual history information 28a of the user A, the workflow shared history information 291a of the workflow a, and the group shared history information 292a of the group α.

FIG. 3 shows information stored in the storage device 21 of the image processing device 2 with the voice operation function. Information stored in the respective storage device 21 of the other image processing devices 3 and 4 not including the voice operation function is the same as the information illustrated in FIG. 3 with the exception of the speech recognition dictionary 25 and the operation item distinguish table 26.

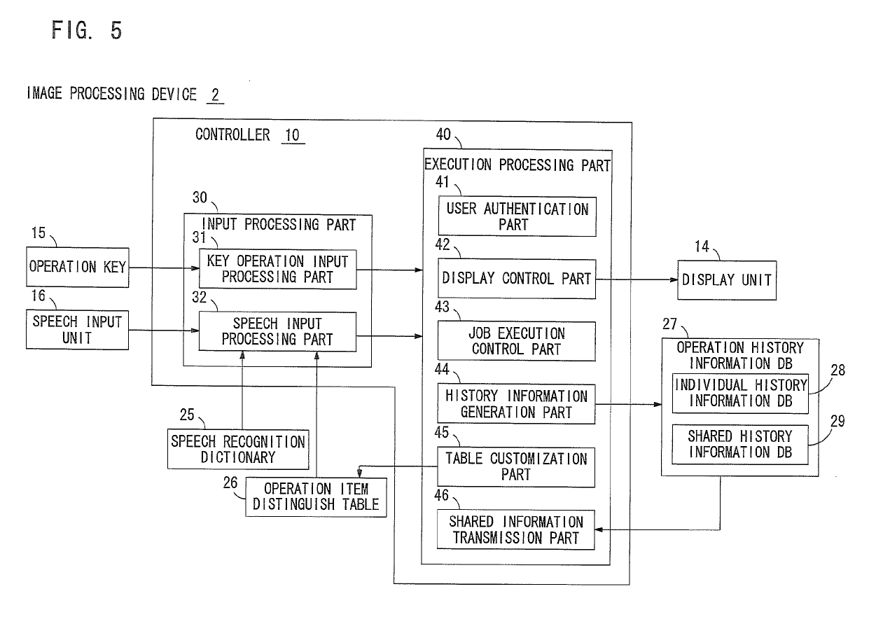

FIG. 5 is a block diagram showing an exemplary configuration relating to the function of the controller 10 in the image processing device 2. As shown in FIG. 5, the controller 10 functions as an input processing part 30 and an execution processing part 40. The input processing part 30 includes a key operation input processing part 31 for executing processing corresponding to key operation input in response to manual operation of the operation key 15, and a speech input processing part 32 for executing processing corresponding to speech signal input through the speech input part 16. The execution processing part 40 applies the input operation made by the user (including both manual operation and voice operation), and includes a user authentication part 41, a display control part 42, a job execution control part 43, a history information generation part 44, a table customization part 45 and a shared information transmission part 46.

The key operation input processing part 31 specifies key operation when the key operation of the operation key 15 is made by the user. The key operation specified by the key operation input processing part 31 is provided to the execution processing part 40. The provided key operation is then applied by the execution processing part 40.

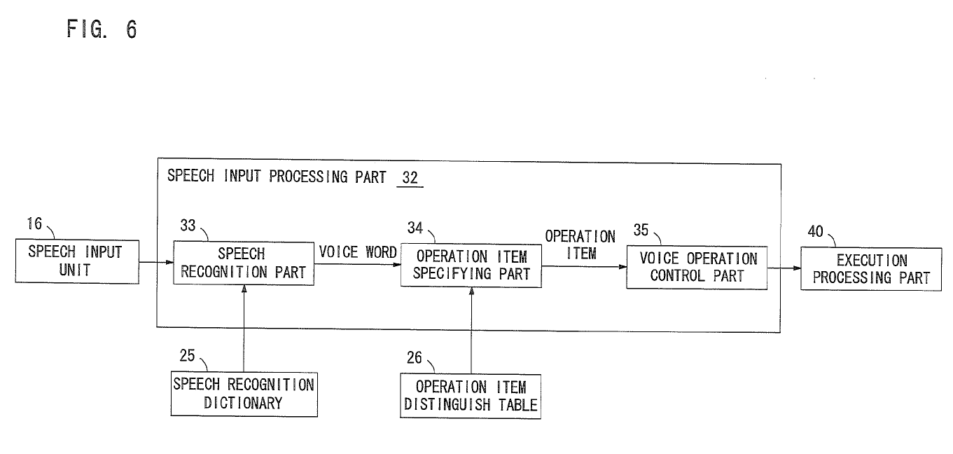

The speech input processing part 32 processes speech signal input through the speech input part 16. FIG. 6 is a block diagram showing the detailed configuration of the speech input processing part 32. As illustrated in FIG. 6, the speech input processing part 32 includes a speech recognition part 33, an operation item specifying part 34 and a voice operation control part 35.

The speech recognition part 33 refers to the speech recognition dictionary 25, thereby identifying a voice word from speech signal input through the speech input part 16. By way of example, the speech recognition part 33 analyzes speech signal which is analog signal and refers to the speech recognition dictionary 25, thereby identifying voice word corresponding to the speech signal. More specifically, for instance, the user inputs a word “duplex” by speech to the speech input part 16, the speech recognition part 33 analyzes its speech signal, searches a word included in the speech signal one by one based on the speech recognition dictionary 25, and finally identifies a voice word “DUPLEX” which was said by the user. The speech recognition part 33 outputs the identified voice word to the operation item specifying part 34 thereafter.

The operation item specifying part 34 specifies operation item corresponding to the voice word input by the user by speech. The operation item specifying part 34 specifies operation item corresponding to the voice word by reference to the operation item distinguish table 26 stored in the storage device 21.

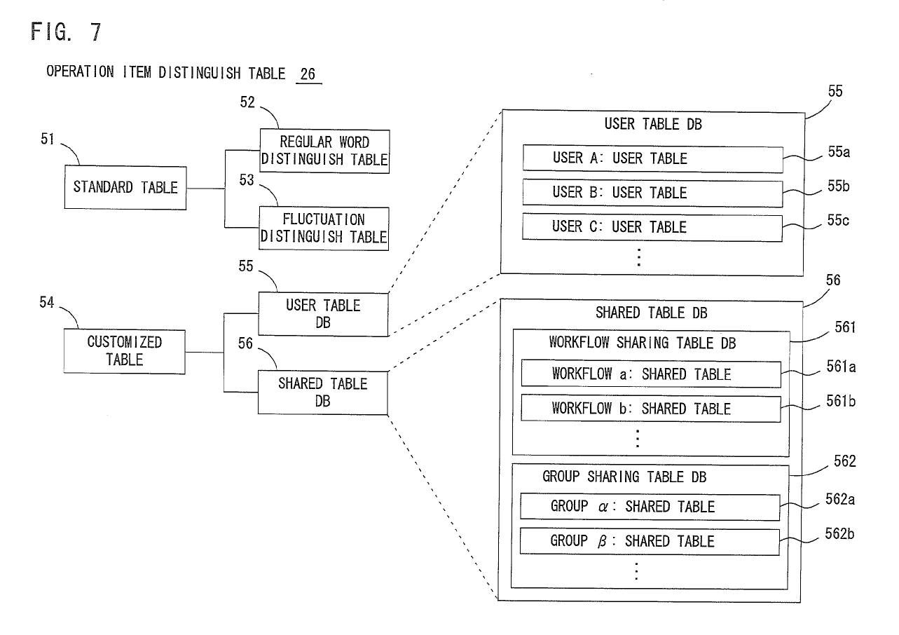

The operation item distinguish table 26 is information in which correspondence relation between the voice word and operation item is recorded in a form of table. FIG. 7 is an exemplary structure of the operation item distinguish table 26. As shown in FIG. 7, the operation item distinguish table 26 includes a standard table 51 and a customized table 54.

The standard table 51 in the preferred embodiment is installed as standard in the image processing device 2 with the voice operation function, and is a standard table which is set by default in order for an operation item to be specified from input voice word. This standard table 51 includes a regular word distinguish table 52 and a fluctuation distinguish table 53. The regular word distinguish table 52 is a table in which a voice word which perfectly matches a name of operation item and an operation item are associated. So, for example, for an operation item to make settings of “duplex,” “DUPLEX” is registered as a voice word. In contrast, the fluctuation distinguish table 53 is registered in advance in order for an operation item corresponding to a name to be specified even when the voice word does not perfectly match the name of the operation item is input. So, for instance, for the operation item to make settings of “duplex,” “TWO-SIDED” is registered as the voice word. In this case, when the user inputs “two-sided” by speech to the speech input part 16, the image processing device 2 configures duplex setting in accordance with the speech input.

The customized table 54 includes a table created when a combination of a voice word and an operation item which is not contained in the standard table 51 is newly registered by the user. A combination of a voice word and an operation item that the user desires may be registered in this customized table 54. The customized table 54 is created by the table customization part 45 of the execution processing part 40, and in which a new combination of a voice word and an operation item is registered.

As shown in FIG. 7, a user dedicated user table database (hereinafter stated as “user table DB”) 55 created for each user and a shared table database (hereinafter stated as “shared table DB”) 56 shared by one or more users are included in the customized table 54.

The user table DB 55 stores therein user tables 55a, 55b, 55c and others created for the respective user individually. Each user makes an operation for registering a new combination of a desired voice word and an operation item. The information in which the voice word and the operation item are associated is then registered into the respective user tables 55a, 55b and 55c corresponding to the user.

The information in which the voice word and the operation item are associated is stored in the shared table DB 56. The information stored in the shared table DB 56 is to be shared by one or more users. This shared table DB 56 contains a workflow sharing table database (hereinafter stated as “workflow sharing table DB”) 561 and a group sharing table database (hereinafter stated as “group sharing table DB”) 562 as illustrated in FIG. 7.

Shared tables 561a, 561b and others created at a level of one or more users who share a predetermined workflow, more specifically, at a level of a workflow are stored in the workflow sharing table DB 561. Each of the shared tables 561a and 561b stores therein the new combination of the voice word and the operation item registered by individual user who shares the workflow. These shared tables 561a and 561b are allowed to be commonly used by one or more users who share the same workflow.

Shared tables 562a, 562b and others created for each of user's group are stored in the group sharing table DB 562. The new combination of the voice word and the operation item registered by the user belongs to the respective group is stored in each of the shared tables 562a and 562b. These shared tables 562a and 562b are allowed to be commonly used by one or more users who belong to the same group.

As a new combination of a voice word and an operation item is registered by a user, the combination is registered not only in the user table DB 55 corresponding to the user but also to the shared table DB 56 with which the user is associated. More specifically, for instance, it is assumed that the user A shares the workflow a and whose group is the group α. When operation for registering a new combination of desired voice word and an operation item is made by the user A, the information in which the voice word and the operation item are associated is stored into the user table 55a of the user A, the shared table 561a of the workflow a and the shared table 562a of the group α, respectively.

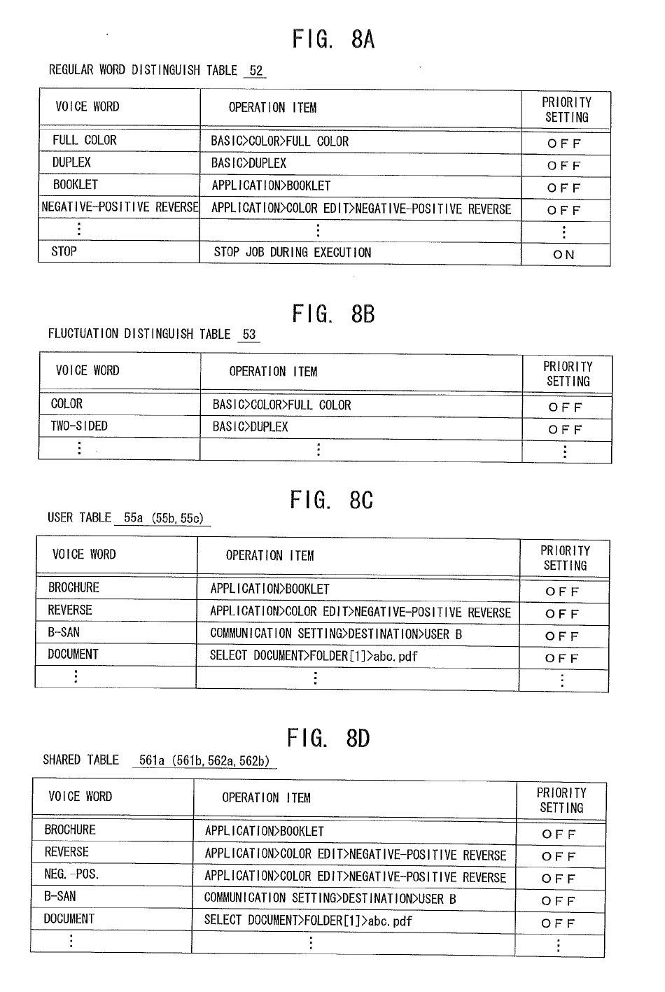

FIGS. 8A, 8B, 8C and 8D are examples of each above-described table contained in the operation item distinguish table 26. FIG. 8A shows the regular word distinguish table 52. As described above, the voice word that perfectly matches the name of the operation item and corresponding operation item are associated in the regular word distinguish table 52. A menu item “duplex” positioned at one level lower than a menu item “basic setting” on the menu screen is associated with the voice word “DUPLEX” as the operation item, for example. When the user makes input of “duplex” by speech, “duplex” is specified as the operation item corresponding to the voice word by reference to the regular word distinguish table 52. The duplex setting is then applied at the execution processing part 40.

FIG. 8B shows the fluctuation distinguish table 53. As described above, the voice word that does not perfectly match the name of the operation item and corresponding operation item are associated in the fluctuation distinguish table 53. A menu item “duplex” positioned at one level lower than a menu item “basic setting” on the menu screen is associated with the voice word “TWO-SIDED” as the operation item, for instance. Even when the user makes input of “two-sided” by speech, “duplex” is specified as the operation item corresponding to the voice word by reference to the fluctuation distinguish table 53. The duplex setting is then applied at the execution processing part 40.

FIG. 8C shows an example of the user table 55a. As described above, a combination of a voice word and an operation item which is not included neither in the regular word distinguish table 52 nor in the fluctuation distinguish table 53, and which is desired by the user is registered in the user table 55a. As for example, it is assumed a menu item “negative-positive reverse” positioned at two levels lower than a menu item “application setting” on the menu screen is associated with a voice word “REVERSE” as the operation item. As the user makes input of “reverse” by speech, “negative-positive reverse” is specified as the operation item corresponding to the voice word by reference to the user table 55a. So, the negative-positive reverse setting is applied at the execution processing part 40. In the regular word distinguish table 52, “negative-positive reverse” is associated with the voice word “NEGATIVE-POSITIVE REVERSE” as the operation item. However, as “NEGATIVE-POSITIVE REVERSE” accompanies a relatively long speech, the user is allowed to register abbreviation or a word that he or she is easy to say in the user table 55a. The structures of other user tables 55b and 55c are the same as the one of the user table 55a. However, the combination of the voice word and the operation item registered in respective table may differ.

In the example shown in FIG. 8C, an operation item for designating “user B” as destination address is registered as an operation item corresponding to a voice word “B-SAN.” Also, an operation item designating document data (abc.pdf) saved in a folder [1] is registered as an operation item corresponding to a voice word “DOCUMENT.”

FIG. 8D shows an example of the shared table 561a. In this shared table 561a, a combination of a voice word and an operation item shared by one or more users is registered. By way of example, the voice words “BROCHURE,” “REVERSE” and others are registered as the same combinations as those in the user table 55a shown in FIG. 8C. As for the voice word “NEG.-POS.,” the combination of the voice word and the operation item is registered by another user. The menu item “negative-positive reverse” positioned at two levels lower than the menu item “application setting” on the menu screen is associated with the voice word “NEG.-POS.” as the operation item. So, in case of making input of either “REVERSE” or “NEG.-POS.” by speech by the user, “negative-positive reverse” is specified as the operation item corresponding to the input word by reference to the shared table DB 56. So, the negative-positive reverse setting is applied at the execution processing part 40. The structures of other shared tables 561b, 562a and 562b are the same as the one of the shared table 561a. However, the combination of the voice word and the operation item registered in respective table may differ.

As shown in FIGS. 8A, 8B, 8C and 8D, priority setting during job execution is registered for the combination of the voice word and the operation item in each table. The voice word of which ON is defined in its field of priority setting during job execution is used in preference for the determination of the voice word during the job execution. The voice word of which OFF is defined in its field of priority setting during job execution is used in not preference for the determination of the voice word during the job execution. For the example of FIG. 8A, the field of priority setting of a voice word “STOP” is defined as ON in the regular word distinguish table 52. The operation item corresponding to the voice word is a stop key of push-button keys, which is to say the operation to stop the job being executed.

Thus, the operation item specifying part 34 specifies the operation item corresponding to the input voice word by reference to the operation item distinguish table 26. As shown in FIG. 6, after specifying the operation item, the operation item specifying part 34 indicates the operation item to the voice operation control part 35. However, when not being capable of specifying the operation item corresponding to the input voice word, the operation item specifying part 34 indicates that the operation item may not be specified to the voice operation control part 35. By way of example, when the input voice word is not registered in any of the tables in the operation item distinguish table 26, the operation item may not be specified.

The voice operation control part 35 indicates the operation item specified by the operation item specifying part 34 to the execution processing part 40, thereby making the execution processing part 40 to execute processing corresponding to the specified operation item. The image processing device 2 applies the voice operation the user made to it thereafter. When the operation item specifying part 34 could not specify the operation item corresponding to the input voice word, the voice operation control part 35 indicates so to the execution processing part 40.

Returning to FIG. 5, the execution processing part 40 is explained next. The user authentication part 41 executes authentication processing of the user who uses the image processing device 2. When, for instance, user ID, password and others is input through the operation key 15 of the operational panel 13, the user authentication part 41 reads the user information 22 from the storage device 21, and determines whether or not information which matches the input user ID or password is registered, thereby executing user authentication. If the matching information is contained in the user information 22, the user who uses the image processing device 2 may be identified. So, the authentication results in success, and the image processing device 2 transits to a logged-in state in which the identified user is logging in. Here, the user thereby authenticated becomes a logged-in user.

The display control part 42 controls the display screen of the display unit 14. The display control part 42 reads the display screen information 24 stored in the storage device 21, and displays the menu screen on the display unit 14 of the operational panel 13. When the user operates the operational panel 13 by manual or by speech, the display control part 42 changes the display screen of the display unit 14 to a screen that incorporates the manual operation or the voice operation. As a job is instructed with manual operation or voice operation made by the user, the execution of the job is started in the image processing device 2. At the same time, the display control part 42 changes the display screen of the display unit 14 to a screen during job execution.

In addition, the display control part 42 reads the manual operation history information 81 and the voice operation history information 82 relating to the logged-in user from the individual history information DB 28 and the shared history information DB 29 included in the operation history information DB 27, thereby being capable of displaying operation history recorded in those manual operation history information 81 or the voice operation history information 82. In this case, when one operation history is selected by the logged-in user from a plurality of operation histories displayed on the display unit 14, the detail of past operation that the operation thereby selected indicates is applied to the image processing device 2 as this operation.

As the execution of the job is instructed by the logged-in user, the job execution control part 43 controls the operation of the scanner unit 17, the image memory 18, the printer unit 19, the network interface 20 and the storage device 21 selectively as needed, thereby executing the specified job.

The history information generation part 44 generates operation history information and updates the operation history information DB 27 stored in the storage device 21 every time manual operation or voice operation is made by the user. When the operation made by the user is by manual, the history information generation part 44 additionally registers the operation history in the manual operation history information 81 of the individual history information 28a, 28b and 28c corresponding to the user. Also, if the workflow shared history information 291a or 291b, and/or the group shared history information 292a or 292b relating to the user is present, the operation history is additionally registered in the manual operation history information 81 contained in each information relating to the user.

When the operation made by the user is by speech, the history information generation part 44 additionally registers the operation history in the voice operation history information 82 of the individual history information 28a, 28b or 28c corresponding to the user. In addition, if the workflow shared history information 291a or 291b, and/or the group shared history information 292a or 292b relating to the user is present, the operation history is additionally registered in the voice operation history information 82 contained in each information relating to the user.

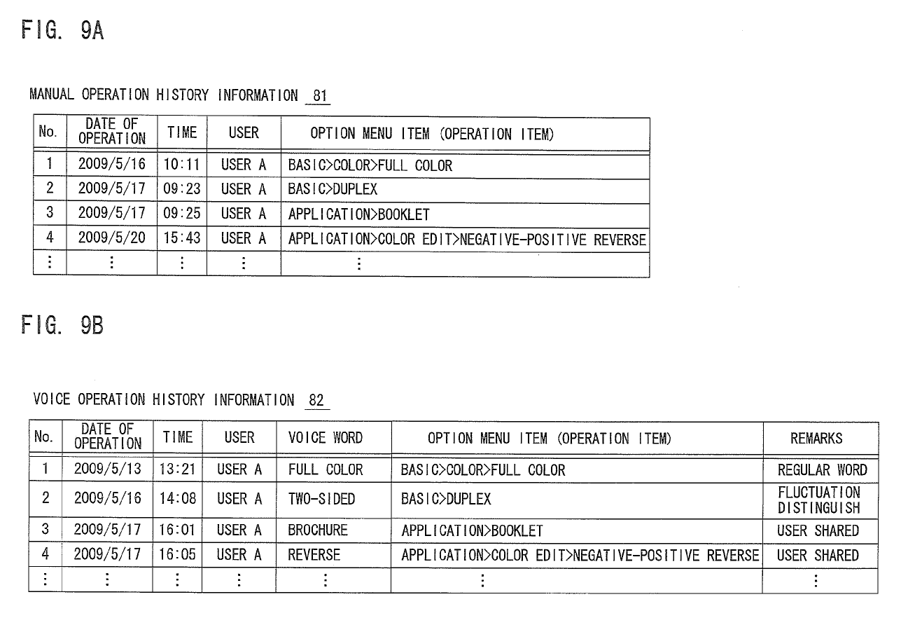

FIGS. 9A and 9B are examples of the manual operation history information 81 and the voice operation history information 82 contained in the operation history information DB 27. FIG. 9A shows the manual operation history information 81. As shown in FIG. 9A, the manual operation history information 81 in which information such as time and date of manual operation, user name and selected operation item is recorded. FIG. 9B shows the voice operation history information 82. As shown in FIG. 9B, the voice operation history information 82 in which information such as time and date of voice operation, user name, input voice word, selected operation item, and remarks information are recorded. As referring to the voice operation history information 82 illustrated in FIG. 9B, correspondence relation between the voice word the user A input by speech and the operation item selected in response to the voice word may be identified. In the remarks column of the voice operation history information 82, it is recorded that the voice word is registered in which table of the regular word distinguish table 52, the fluctuation distinguish table 53, any of the user tables 55a, 55b and 55c, or any of the shared tables 561a, 561b, 562a and 562b contained in the operation item distinguish table 26.

When the user made an operation to register a correspondence relation between a desired voice word and an operation item, the table customization part 45 additionally registers the correspondence relation to the operation item distinguish table 26. To be more specific, this table customization part 45 registers a combination of a voice word and an operation item that the user desires in the above-described user table DB 55 and/or shared table DB 56, thereby updating the operation item distinguish table 26.

The shared information transmission part 46 transmits information to be shared by the plurality of image processing devices 2, 3 and 4 connected to the network 9. When the voice operation history information 82 contained in the operation history information DB 27 is updated by the history information generation part 44, the shared information transmission part 46 of the first preferred embodiment reads the updated voice operation history information 82 from the storage device 21, and transmits to other image processing devices 3 and 4 through the network 9.

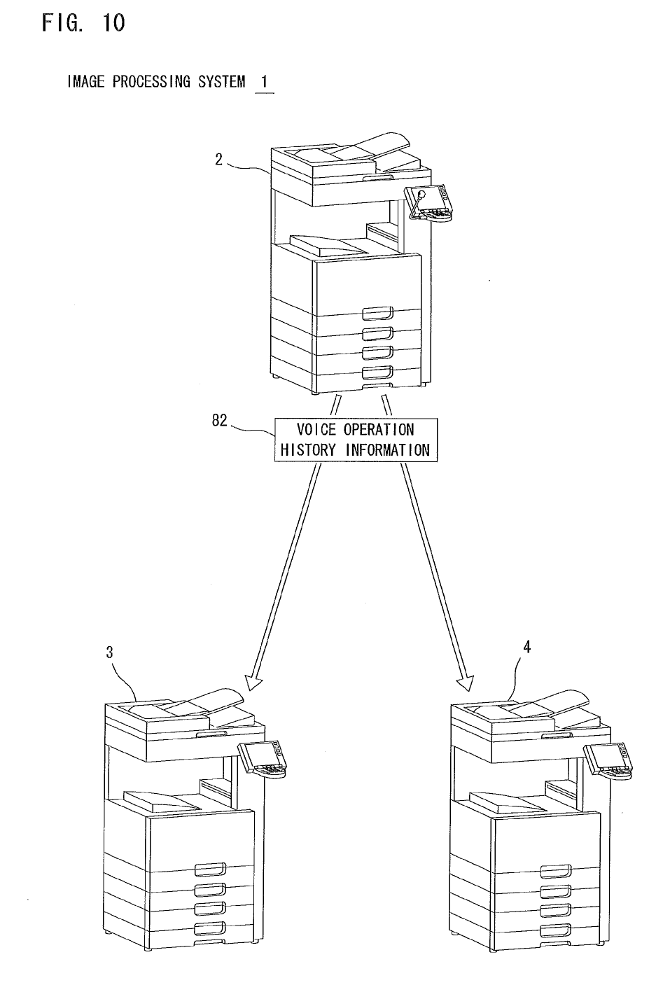

FIG. 10 shows an exemplary transmission processing of the voice operation history information 82 executed by the shared information transmission part 46. In the first preferred embodiment, after the update of the voice operation history information 82 in the image processing device 2 with the voice operation function, the image processing device 2 transmits the voice operation history information 82 to other image processing devices 3 and 4 as illustrated in FIG. 10. So, according to the first preferred embodiment, the voice operation history information 82 is shared and used by the plurality of image processing devices 2, 3 and 4 connected to the network 9.

Neither of the image processing devices 3 nor 4 includes the voice operation function. However, each of those image processing devices 3 and 4 inputs the voice operation history information 82 from the image processing device 2, thereby being capable of identifying the detail of the voice operation made by the user and its history.

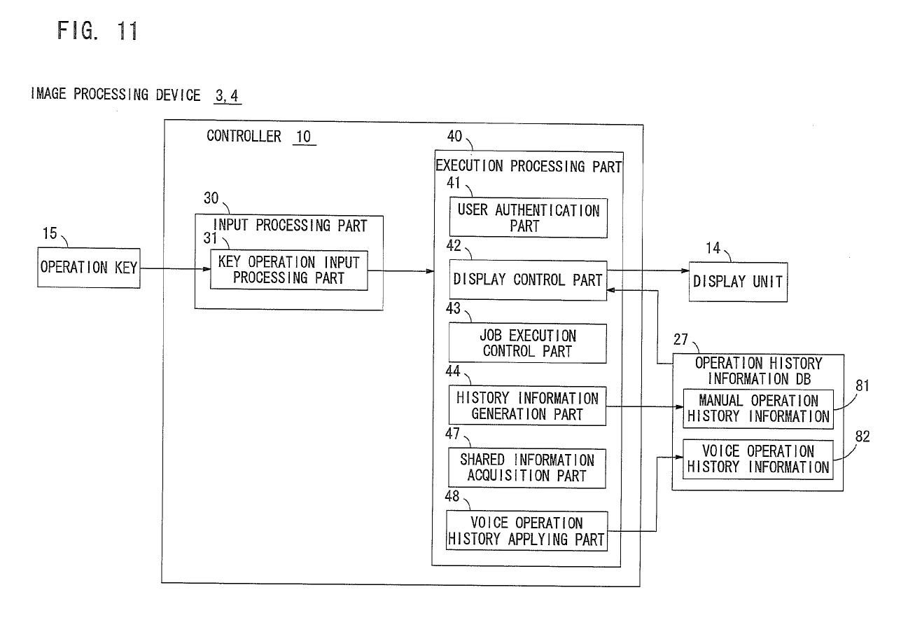

FIG. 11 is a block diagram showing an exemplary configuration in reference to functions realized by the controller 10 of each of the image processing devices 3 and 4. As shown in FIG. 11, the controller 10 functions as the input processing part 30 and the execution processing part 40. The input processing part 30 of each of the image processing devices 3 and 4 only includes the key operation input processing part 31 which executes processing based on manual operation of the operation key 15. The execution processing part 40 of each of the image processing devices 3 and 4 applies input operation (only manual operation) made by the user, and includes the user authentication part 41, the display control part 42, the job execution control part 43, the history information generation part 44, a shared information acquisition part 47 and a voice operation history applying part 48. In the first preferred embodiment, the key operation input processing part 31 of the input processing part 30 is the same as the one equipped with the image processing device 2. Also, the user authentication part 41, the display control part 42, the job execution control part 43 and the history information generation part 44 are the same as ones of the image processing device 2. However those processing parts only receive manual operation and execute the respective processing for the image processing devices 3 and 4.

The shared information acquisition part 47 acquires information to be shared by the plurality of image processing devices 2, 3 and 4 connected to the network 9. After receiving the voice operation history information 82 transmitted by the image processing device 2 through the network 9, the shared information acquisition part 47 of the first preferred embodiment outputs the voice operation history information 82 thereby received to the voice operation history applying part 48.

The voice operation history applying part 48 associates a menu item on the menu screen of the display unit 14 with a voice word based on the voice operation history information 82 that acquired by the shared information acquisition part 47, and saves the voice operation history information 82 in the operation history information DB 27 stored in the storage device 21. Therefore, even though the image processing devices 3 and 4 do not include the voice operation function, the voice operation history information 82 of the image processing device 2 is held, respectively. Data structure of the operation history information DB 27 in each of the image processing devices 3 and 4 is the same as the one in the image processing device 2.

When matching the menu item on the menu screen of the display unit 14 and a voice word are associated based on the voice operation history information 82 acquired by the shared information acquisition part 47, the voice operation history applying part 48 associates the voice word only if the menu item to be associated with the voice word is available in each of the image processing devices 3 and 4. That is to say, the voice operation history applying part 48 reads the equipped function information 23 from the storage device 21 and specifies only menu items as to functions available in each of the image processing devices 3 and 4. Only the voice word corresponding to the specified menu item is to be associated with the menu item thereafter. By way of example, it is assumed duplex setting of a function such as the copy function is available in the image processing device 2, but not in the image processing devices 3 and 4. In this case, even when history in reference to “duplex setting” is contained in the voice operation history information 82 that the image processing device 3 or 4 receive from the image processing device 2, a voice word is associated with nothing, that is why “duplex setting” is not the menu item available in the image processing device 3 or 4. On the other hand, it is assumed “duplex setting” is also available in each of the image processing devices 3 or 4. In that case, when history in reference to “duplex setting” is contained in the voice operation history information 82 that the image processing device 3 or 4 receive from the image processing device 2, a voice word contained in the history and the menu item “duplex setting” are associated, that is because “duplex setting” is the menu item which is also available in the image processing device 3 or 4.

In the image processing device 3 or 4, the display control part 42 displays the voice word associated by the voice operation history applying part 48 on the display unit 14 of the operational panel 13. There are various examples of ways of displaying the voice word. Those examples are described later. The display control part 42 displays the voice word on the display unit 14. As a result, for example, the user who normally uses the image processing device 2 with voice operation by inputting a voice word by speech is allowed to make desired operation by manual based on the voice word displayed on the display unit 14 when he or she uses the image processing device 3 or 4.

According to the first preferred embodiment, the voice operation history information 82 is to be shared by the plurality of image processing devices 2, 3 and 4. Therefore, especially in the image processing device 3 or 4 that does not include the voice operation function may receive manual operation in response to the voice word based on the voice operation history information 82 received from the image processing device 2. Also, the operation may be applied to the image processing device 3 or 4. Operations of those image processing devices 2, 3 and 4 are hereinafter described in detail.

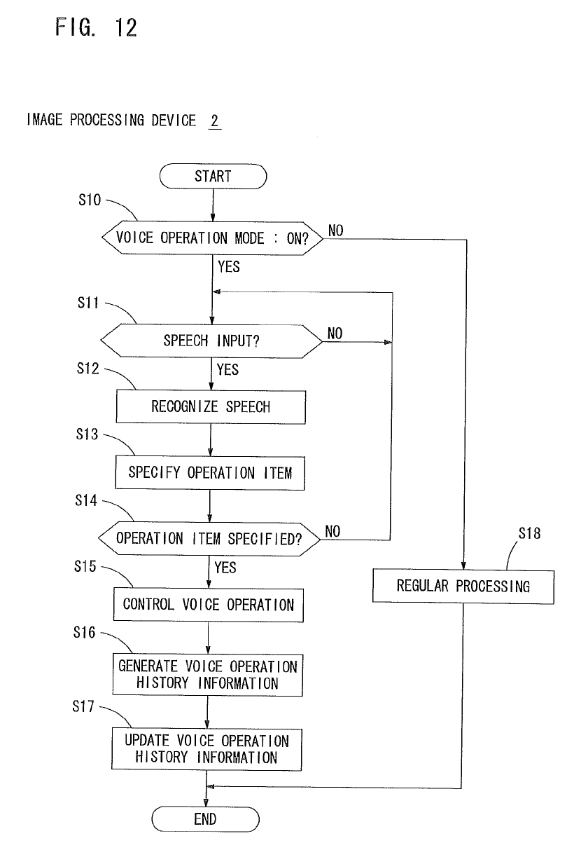

FIG. 12 is a flow diagram explaining an exemplary procedure of a processing to update the voice operation history information 82 in the image processing device 2. This processing is realized by the controller 10 of the image processing device 2. When voice operation mode of the image processing device 2 is being ON (when a result of step S10 is YES), the controller 10 determines whether or not speech input is made (step S11). When speech input is not made, the controller 10 is put into a waiting state for speech input (when a result of step S11 is NO). When speech input is made (when a result of step S11 is YES), the controller 10 executes speech recognition processing based on the speech recognition dictionary 25 (step S12), then executes operation item specifying processing based on the operation item distinguish table 26 (step S13). Next, the controller 10 determines whether or not an operation item corresponding to the input voice word has been specified (step S14). If the operation item may be specified, the controller 10 executes voice operation control processing to apply the specified operation item to the image processing device 2 (step S15). Processing for applying the operation item to the image processing device 2 includes processing, such as that to set setting item corresponding to operation item selected with voice operation, to update the display screen of the display unit 14 in response to the setting to start job execution, to stop job during execution, and to update the display screen of the display unit 14 in response to start of job execution or stop. If operation item may not be specified (when a result of step S14 is NO), the process returns to step S11, and the controller 10 is put into the waiting state for next speech input.

When the voice operation control processing (step S15) is executed, the controller 10 generates voice operation history information based on the detail of the processing (step S16), and updates the voice operation history information 82 stored in the storage device 21 (step S17). As executing such processing, the voice operation history information 82 stored in the image processing device 2 is updated every time voice operation is made with speech input by the user.

When voice operation mode is being OFF (when a result of step S10 is NO), the controller 10 executes regular processing which receives only manual operation (step S18). In the regular processing receives only operation made by manual by the user. In response to manual operation, the manual operation history information 81 is updated after execution of processing based on the manual operation.

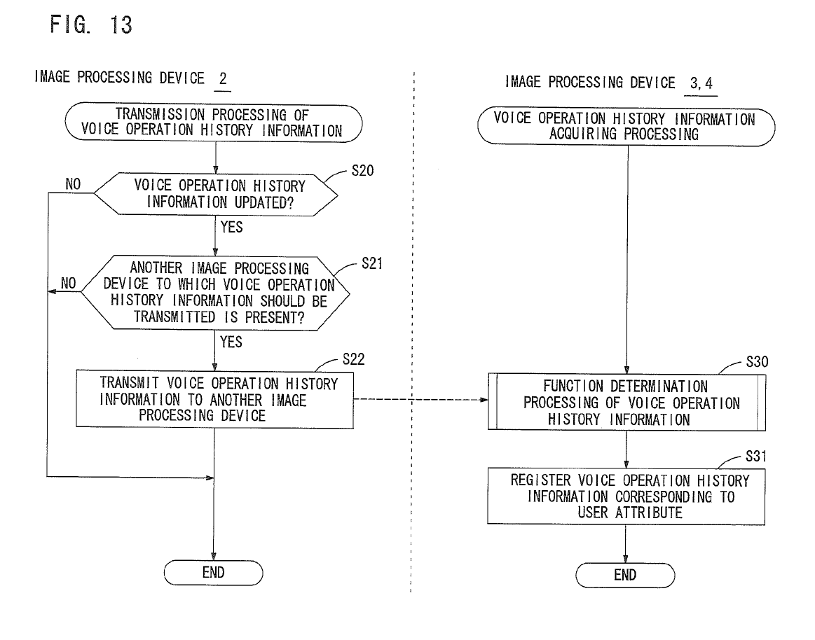

FIG. 13 is a flow diagram explaining an exemplary procedure of a processing to transmit the voice operation history information 82 from the image processing device 2 to the image processing devices 3 and 4. With regard to this flow diagram, transmission processing of the voice operation history information executed by the image processing device 2 is, for example, a processing which is repeatedly executed at a constant period by the controller 10 of the image processing device 2. The controller 10 of the image processing device 2 determines whether or not the voice operation history information 82 stored in the storage device 21 is updated (step S20). If the voice operation history information 82 is not updated (when a result of step S20 is NO), this processing is completed. If the voice operation history information 82 is updated (when a result of step S20 is YES), the controller 10 then checks whether or not another image processing device 3 and/or 4 should be transmitted the voice operation history information 82 is present in the network 9 (step S21).

In this check processing, for instance, whether or not an image processing device in which a user who has the same user attribute as the one of the user who made the voice operation to the image processing device 2 is registered is present among other image processing devices 3 and 4 connected to the network 9. If another image processing device in which a user who has the same user attribute is registered is present, the image processing device is extracted as a target of transmission of the voice operation history information 82. The user attribute in the first preferred embodiment includes information such as that for identifying a user that indicating a group of the user, or that related to a workflow with which the user is registered as a person in charge of processing. So, for example, it is assumed the user A made the voice operation with the image processing device 2. In that case, if the user A is registered in the user information 22 of the image processing device 3 or 4 as a user who is authorized to use the respective image processing devices 3 and 4, the image processing device 3 and/or 4 id extracted as the target of transmission of the voice operation history information 82. In addition, it is assumed the user A is not registered in the user information 22 of the image processing device 3 or 4 as a user who is authorized to use the respective image processing devices 3 and 4, but another user whose group is the same as the user A's or another user who shares a workflow with the user A is registered in the user information 22 of each of the image processing device 3 or 4 as a user who is authorized to use the respective image processing device 3 and/or 4. In such case, the image processing device 3 and/or 4 is extracted as the target of transmission of the voice operation history information 82.

As another image processing device 3 and/or 4 which should be transmitted the voice operation history information 82 is present (when a result of step S21 is YES), the controller 10 of the image processing device 2 transmits the updated voice operation history information 82 to the another image processing device 3 and/or 4 (step S22). As another image processing device 3 and/or 4 which should be transmitted the voice operation history information 82 is not present (when a result of step S21 is NO), the processing is completed.

After receiving the voice operation history information 82 from the image processing device 2 through the network 9, the image processing device 3 and/or 4 executes function determination processing of the voice operation history information 82 (step S30) and processing to register the received voice operation history information 82 corresponding to the user attribute (step S31), sequentially.

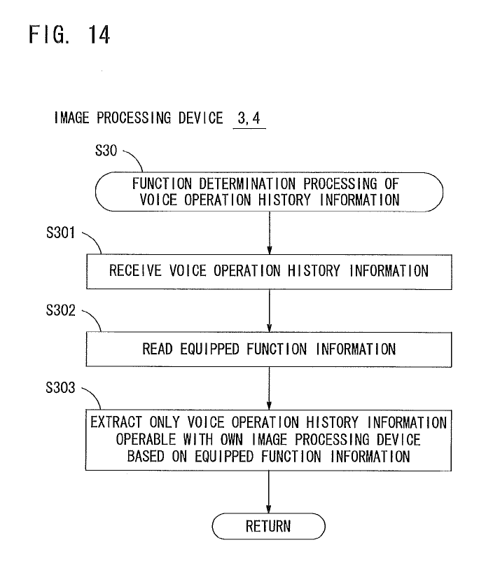

FIG. 14 is a flow diagram explaining the process sequence of the function determination processing of the voice operation history information 82 in the image processing device 3 or 4 in detail. In this processing, after receiving the voice operation history information 82 that transmitted from the image processing device 2 (step S301), each controller 10 of the image processing devices 3 and 4 reads the equipped function information 23 stored in each storage device 21 (step S302). Each controller 10 of the image processing devices 3 and 4 then extracts only voice operation history information concerning a menu item which is operable with own image processing device 3 or 4 from the voice operation history information 82 received from the image processing device 2 based on its equipped function information 23 (step S303). So, a voice word with which a menu item that is not operable with own image processing device 3 or 4 is associated is to be eliminated from a target of registration here.

Returning to FIG. 13, each controller 10 of the image processing devices 3 and 4 registers only voice operation history information concerning a menu item which is operable with own image processing device 3 or 4 extracted from the voice operation history information 82 received from the image processing device 2 in the voice operation history information 82 corresponding to user attribute of the individual history information DB 28 and/or the shared history information DB 29 contained in the operation history information DB 27 (step S31). In the first preferred embodiment, the extracted voice operation history information is registered in the voice operation history information 82 included in the operation history information DB 27 stored in each storage device 21 of the image processing devices 3 and 4. However, the extracted voice operation history information is registered in either or both of the individual history information DB 28 created for each user and the shared history information DB 29 shared and used by one or more users corresponding to user attribute.

As the result of the above-described processing, the voice operation history information 82 created in the image processing device 2 is transmitted to another image processing device 3 and/or 4 through the network 9. The voice operation history information 82 concerning a menu item operable with own image processing device 3 or 4 is then registered in each operation history information DB 27. As a result, the voice operation history information 82 received from the image processing device 2 is allowed to be used in each of the image processing devices 3 and 4.

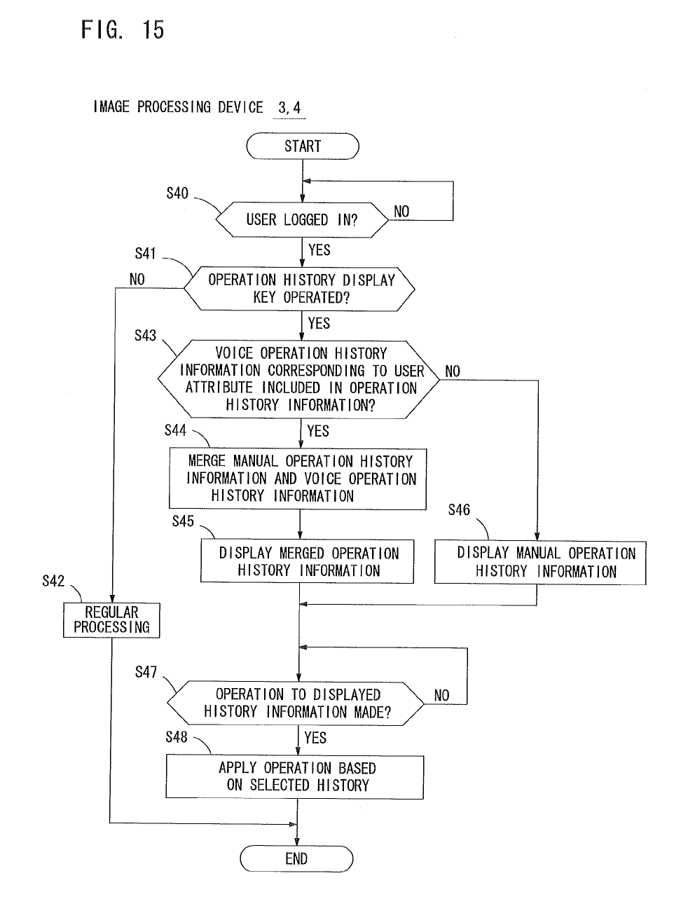

Next, FIG. 15 is a flow diagram explaining an exemplary procedure of a processing for executing operation using the voice operation history information 82 received from the image processing device 2 in the image processing device 3 or 4. At first, each controller 10 of the image processing devices 3 and 4 is put into a waiting state for a user to be logged-in by making operation of the operational panel 13 (step S40). As the user logs into the image processing device 3 or 4 in this state (when a result of step S40 is YES), the controller 10 determines whether or not an operation history display key is operated by the user (step S41). The operation history display key is arranged on the operational panel 13 as one of the push-button keys, for example. If the operation history display key is not operated by the user, the controller 10 of the image processing device 3 or 4 executes regular processing and completes the processing (step S42). In this regular processing (step S42), various types of processing is executed based on manual operation made by the logged-in user and is executed without using the voice operation history information 82.

If the operation history display key is operated by the user (when a result of step S41 is YES), the controller 10 of the image processing device 3 or 4 determines whether or not the voice operation history information 82 corresponding to attribute of the logged-in user is present in the operation history information DB 27 stored in the storage device 21 (step S43). When the voice operation history information 82 corresponding to attribute of the logged-in user is present (when a result of step S43 is YES), the controller 10 executes a processing to merge the manual operation history information 81 corresponding to the attributes of the logged-in user and the voice operation history information 82 (step S44), and displays the merged operation history information on the display unit 14 (step S45).

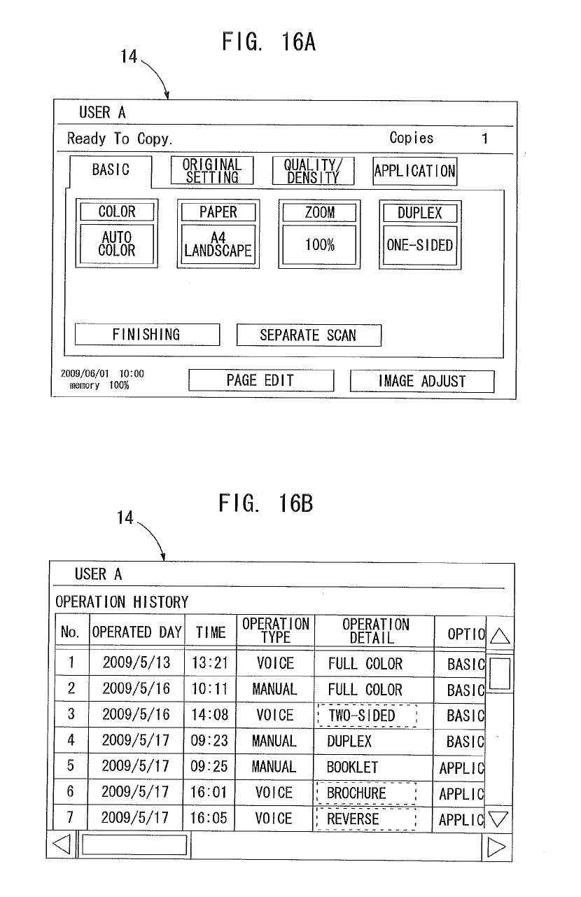

FIGS. 16A and 16B are examples of the display screens displayed on the display unit 14 of the operational panel 13. A screen shown in FIG. 16A is displayed on the display unit 14 of the image processing device 3 or 4, after the user A logs into the image processing device 3 or 4. By way of example, it is assumed the user A makes voice operation with speech input for using the image processing device 2. Also, he or she operates the duplex setting of the copy function with voice operation by inputting a voice word “TWO-SIDED” by speech. In this case, a menu item named “two-sided” is not displayed on the display screen shown in FIG. 16A. So, when making operation to the operational panel 13 by manual, the user A is hard to find which menu item should be selected for duplex setting. In such case, in response to the operation of the operation history display key by the user A, the display screen of the display unit 14 is changed from the display screen of Fig. A to the one shown in FIG. 16B.

As illustrated in FIG. 16B, operation history information displayed on the display unit 14 is displayed in a form that the operation history with manual operation and the one with voice operation are merged. When the user A makes voice operation by speaking “TWO-SIDED” for using the image processing device 2, the voice word “TWO-SIDED” is displayed as the detail of past voice operation on the display unit 14. The user A does not know the formal name of the menu item selected in response to the voice word “TWO-SIDED” is “duplex.” Even in this case, as selecting the history displayed as “TWO-SIDED” on this history display, the user may make the duplex setting to be applied. Operation histories of voice words customized by the logged-in user (such as “BROCHURE” or “REVERSE”) are also displayed on the screen shown in FIG. 16B.

Meanwhile, when the voice operation history information 82 corresponding to attribute of the logged-in user is not present (when a result of step S43 is NO), the controller 10 reads only the manual operation history information 81 corresponding to the attribute of the logged-in user, and displays the read manual operation history information on the display unit 14 (step S46). In this case, the logged-in user may make operation to select from operation histories of past manual operations.

The controller 10 of the image processing device 3 or 4 is put into the waiting state until the operation to select operation history displayed in step S45 or step S46 is made by the logged-in user (step S47). After the operation to select is made by the logged-in user, an operation is applied based on the selected history (step S48). While, for instance, an operation history displayed based on the voice operation history information 82 is selected, the controller 10 applies setting or the like operated by speech in the past to the image processing device 3 or 4 in response to the operation history. Therefore, while the user A selects an operation history displayed “TWO-SIDED,” for example, the duplex setting is applied to the image processing device 3 or 4.

According to the first preferred embodiment, for example, it is assumed that the user A uses the image processing device 2 which include the voice operation history. The user A makes voice operation with the voice word that does not completely match the name of the menu item on the menu screen. In this case, the user A may make operation such as variety of settings with the voice word even when he or she uses another image processing device 3 or 4. Therefore, it enhances the operability.

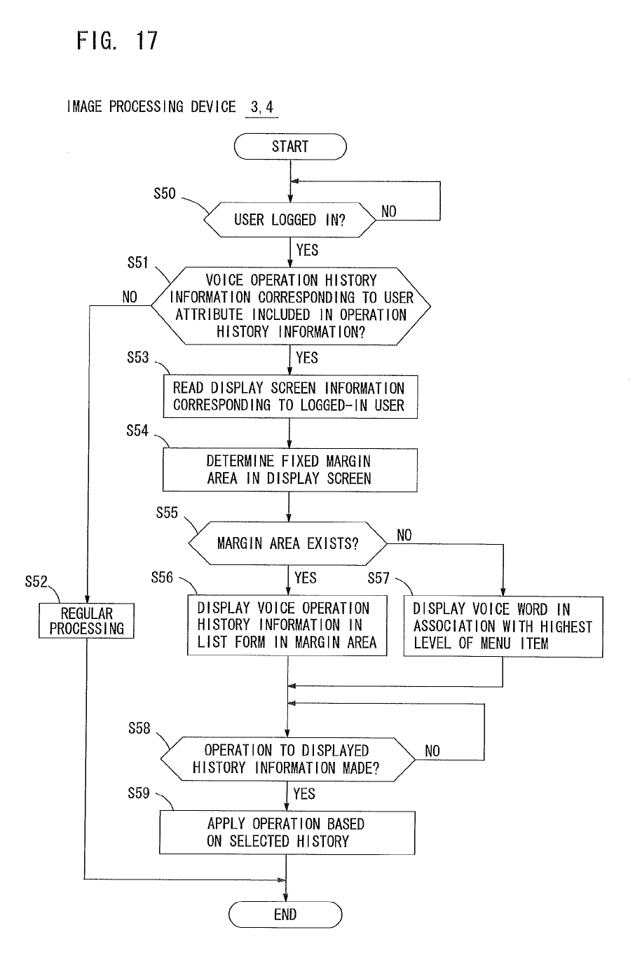

Next, a procedure different from the one in FIG. 15 as described above is explained. FIG. 17 is a flow diagram explaining an exemplary procedure of a processing for executing operation using the voice operation history information 82 received from the image processing device 2 in the image processing device 3 or 4 that is different from the one explained in FIG. 15. As well as the one in FIG. 15, at first of this processing, each controller 10 of the image processing devices 3 and 4 is put into a waiting state for a user to be logged-in by making operation to the operational panel 13 (step S50). As a user logs into the image processing device 3 or 4 in this state (when a result of step S50 is YES), the controller 10 of the image processing device 3 or 4 determines whether or not the voice operation history information 82 corresponding to attribute of the logged-in user is present in the operation history information DB 27 stored in the storage device 21 (step S51). While the voice operation history information 82 corresponding to the attribute of the logged-in user is not present (when a result of step S51 is NO), the controller 10 of the image processing device 3 or 4 executes the regular processing and completes the process (step S52). This regular processing (step S52) is executed without using the voice operation history information 82, and includes various types of processing executed based on manual operation made by the logged-in user.

While the voice operation history information 82 corresponding to the attribute of the logged-in user is present (when a result of step S51 is YES), the controller 10 of the image processing device 3 or 4 reads the display screen information 24 corresponding to the logged-in user (step S53). In the first preferred embodiment, for example, if the menu screen on the highest level at the time of log-in is customized in advance by the logged-in user, the display screen information 24 registered responsive to the customization is read. If the menu screen on the highest level is not customized by the logged-in user, the display screen information 24 set by default as the menu screen on the highest level at the time of log-in is read.

The controller 10 then determines whether or not a fixed margin area exists in the read display screen (step S54). This fixed margin area in the first preferred embodiment is a margin area of a fixed size for the voice operation history information 82 to be displayed in a list form. When the margin area exists (when a result of step S55 is YES), the controller 10 displays the voice operation history information 82 in a list form in the margin area (step S56). When the margin area does not exist (when a result of step S55 is NO), the controller 10 displays the voice word included in the voice operation history information 82 in association with the highest level of the menu item displayed on the menu screen on the highest level (step S57).

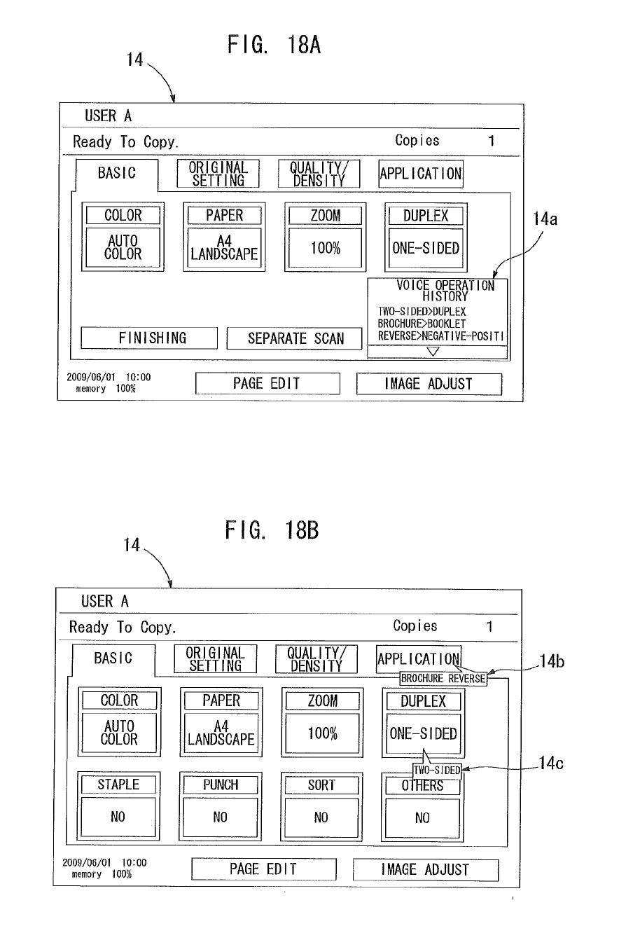

FIGS. 18A and 18B are examples of the display screen displayed on the display unit 14 of the operational panel 13. FIG. 18A is an example of a screen displayed on the display unit 14 in step S56, and FIG. 18B is an example of a screen displayed on the display unit 14 in step S57.

As for example, while plenty of margin space exists in the menu screen on the highest level, a list display field 14a based on the voice operation history information 82 is displayed in the margin space of the menu screen on the highest level as shown in FIG. 18A. In the list display field 14a, operation history with voice operation is then displayed. In this case, the user A may select “two-sided” displayed in the list display field 14a, thereby making the duplex setting.

While plenty of margin space does not exist in the menu screen on the highest level, a voice word that does not completely match with the name of a menu item is displayed in association with the menu item on the highest level displayed on the menu screen on the highest level as shown in FIG. 18B. A voice word 14b, such as “BROCHURE” or “REVERSE,” for example, is associated with a menu item, such as “booklet” or “negative-positive reverse” that is positioned at the lower level of the menu item of application setting, respectively. So, these voice words are displayed in association with the menu item “application setting” on the highest level on the menu screen on the highest level. Also, a voice word 14c of “TWO-SIDED” is associated as the operation corresponding to the menu item “duplex” of basic setting displayed on the menu screen on the highest level. Therefore, this voice word 14c is displayed in association with the menu item “duplex.” As a result, the user A may easily find that which menu item should he or she be selecting to reach to the menu item for setting “two-sided,” “brochure” or “reverse.” Besides, in response to the operation of the voice word 14b or 14c, for example, made by the user directly on the display screen as shown in FIG. 18B, operation corresponding to the voice word 14b or 14c may be applied to the image processing device 3 or 4 without other operations.

Each controller 10 of the image processing devices 3 and 4 is put into the waiting state until operation for selecting history information displayed in step S56 or step S57 is made by the user (step S58). After selecting operation is made by the logged-in user, the controller 10 of the image processing device 3 or 4 applies an operation based on the selected history (step S59). When one of the operation histories displayed in the list display field 14a is selected, or the voice word (14b or 14c) displayed in association with the menu item is selected, setting or the like corresponding to the selected operation history or the voice word is applied to the image processing device 3 or 4. So, for instance, the voice word 14c is displayed as “two-sided” in association with the menu item “duplex.” While the voice word 14c is selected by the user A, the duplex setting is applied to the image processing device 3 or 4.

Therefore, for example, it is assumed the user A makes voice operation with a voice word that does not completely match the name of a menu item on the menu screen for using the image processing device 2 with the voice operation function. In this case, operations, such as variety of settings may be made with the voice word even for using the image processing device 3 or 4. So, the operability is improved.

According to the first preferred embodiment, the example when the image processing device 2 of the plurality of image processing devices 2, 3 and 4 includes the voice operation function, but other image processing devices 3 and 4 do not include is explained. However, the present invention may be applied to the case when other image processing devices 3 and 4 also include the voice operation function as well as the above-described example. In this case, the image processing device 2 acquires the voice operation history information 82 from each of the image processing devices 3 and 4, and incorporates the acquired voice operation history information 82 in own voice operation history information 82. As well as the above description, the image processing device 2 may display the operation history with voice operation in the list display field 14a or display the voice word in association with the menu item.

### Second Preferred Embodiment

A second preferred embodiment of the present invention is described next. In the first preferred embodiment, the voice operation history information 82 is shared by the plurality of image processing devices 2, 3 and 4 as one of information as to voice operation. In the second preferred embodiment, the operation item distinguish table 26 is shared by the plurality of image processing devices.

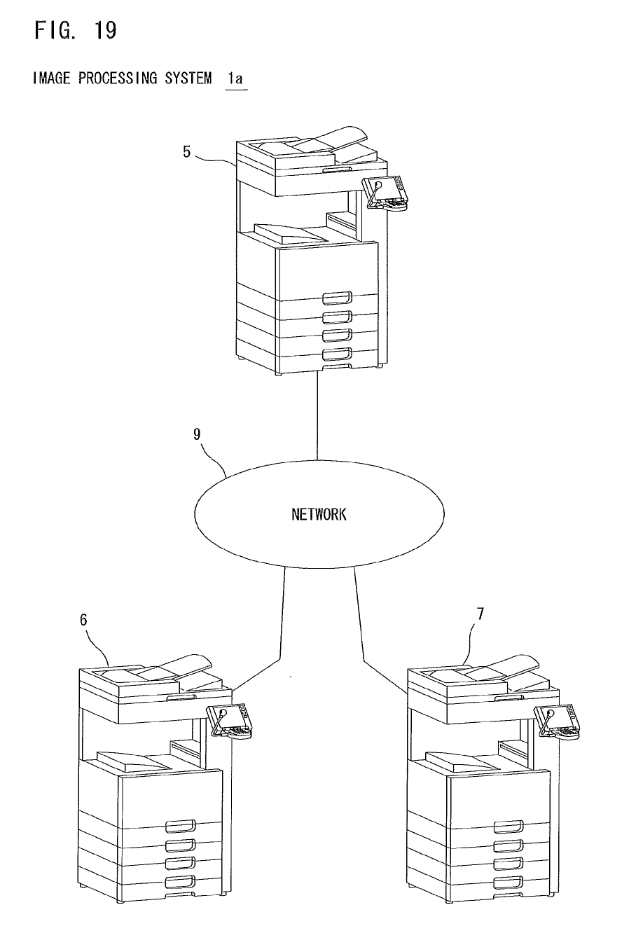

FIG. 19 shows an exemplary configuration of an image processing system 1a of the second preferred embodiment. The image processing system 1a includes a plurality of image processing devices 5, 6 and 7 that are connected to the network 9 including a local network, such as a LAN, an internet network and others. Each of the image processing devices 5, 6 and 7 includes the voice operation function as well as the image processing device 2 described in the first preferred embodiment. So, in the second preferred embodiment, each of the image processing devices 5, 6 and 7 are allowed to be operated by speech with inputting voice. The hardware configuration of each of the image processing devices 5, 6 and 7 is the same as that of the image processing device 2 explained in the first preferred embodiment (see FIG. 2). Various types of information or the like stored in the storage device 21 of each of the image processing devices 5, 6 and 7 is also the same as the ones of the image processing device 2 as described in the first preferred embodiment.

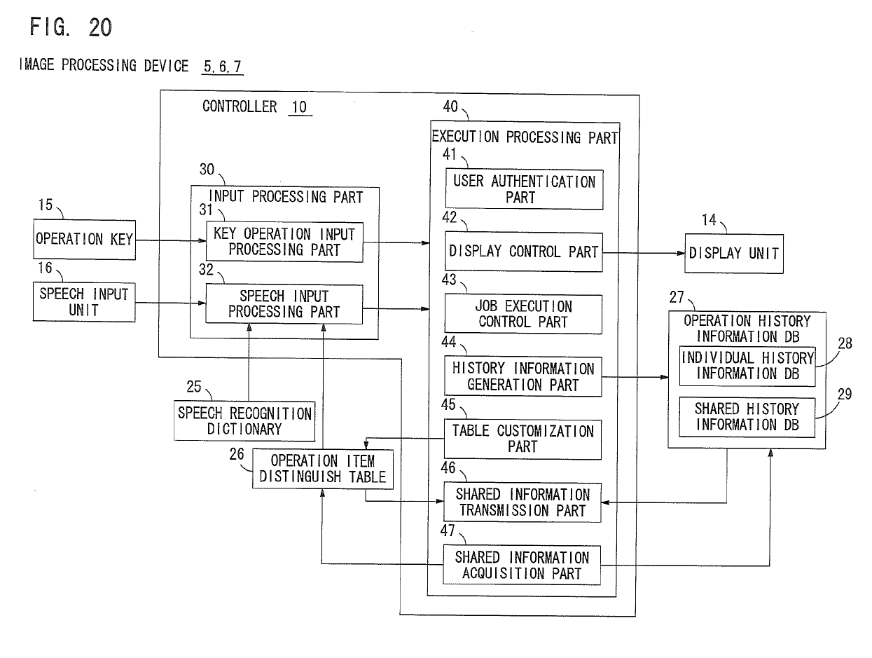

FIG. 20 is a block diagram showing the configuration of functions in the controller 10 of each of the image processing devices 5, 6 and 7. As shown in FIG. 20, the respective controller 10 functions as the input processing part 30 and the execution processing part 40. The input processing part 30 includes the key operation input processing part 31 for executing processing corresponding to key operation input with manual operation to the operation key 15, and the speech input processing part 32 for executing processing corresponding to speech signal input through the speech input part 16. The execution processing part 40 applies the input operation made by the user (including both manual operation and voice operation), and includes the user authentication part 41, the display control part 42, the job execution control part 43, the history information generation part 44, the table customization part 45, the shared information transmission part 46 and the shared information acquisition part 47.

Above-described each part is the same as that described in the first preferred embodiment. In the second preferred embodiment, however, every image processing device 5, 6 or 7 includes the shared information transmission part 46 and the shared information acquisition part 47 that is different from the first preferred embodiment. According to the second preferred embodiment, the data structure of the operation history information DB 27 is the same as the one illustrated in FIG. 4.

When the voice operation history information 82 is updated, the shared information transmission part 46 transmits the updated voice operation history information 82 to other image processing devices. At the same time, when the operation item distinguish table 26 is customized by the user, the shared information transmission part 46 transmits the customized table to other image processing devices. As acquiring the voice operation history information 82 from another image processing device, the shared information acquisition part 47 additionally registers in own voice operation history information 82, thereby sharing the history information of voice operation. Also, as receiving the operation item distinguish table 26 from another image processing device, the shared information acquisition part 47 incorporates in own operation item distinguish table 26, thereby sharing information for distinguishing an operation item. The transmission processing and the acquisition processing of the voice operation history information 82 are the same as those described in the first preferred embodiment, so sharing of the operation item distinguish table 26 is explained in detail herein below.

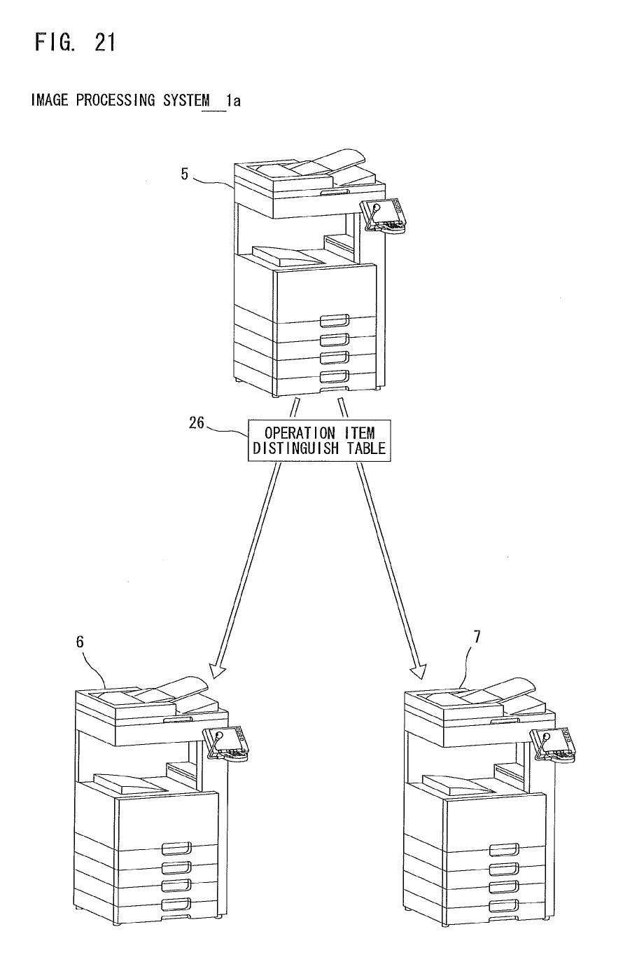

FIG. 21 is a flow diagram explaining an exemplary procedure of a transmission processing of the operation item distinguish table 26 executed by the shared information transmission part 46. As for instance shown in FIG. 21, after the operation item distinguish table 26 is updated in response to customization in the image processing device 5, the operation item distinguish table 26 is transmitted from the image processing device 5 to each of the image processing devices 6 and 7. So, according to the second preferred embodiment, the operation item distinguish table 26 is shared and used by the plurality of image processing devices 5, 6 and 7 connected through the network 9. The image processing device 5 transmits the operation item distinguish table 26 to other image processing devices 6 and 7, thereby sharing with other image processing devices 6 and 7. Especially operation in each of the image processing devices 5, 6 and 7 is explained in more detail herein below.

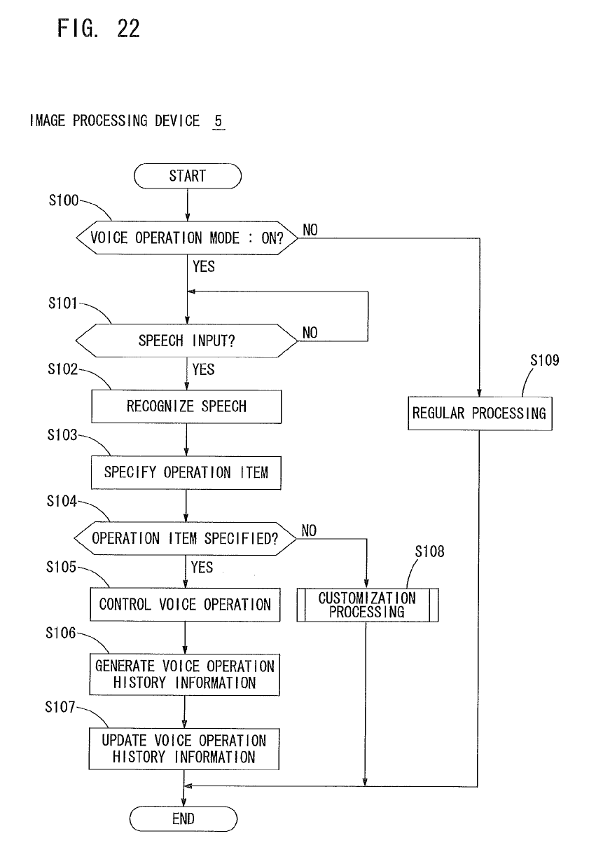

FIG. 22 is a flow diagram explaining an exemplary procedure of a processing for updating the operation item distinguish table 26 in the image processing device 5. This processing is realized by the controller 10 of the image processing device 5. When the voice operation mode of the image processing device 5 is being ON (when a result of step S100 is YES), the controller 10 determines whether or not speech input is made (step S101). When speech input is not made, the controller 10 is put into the waiting state for speech input (when a result of step S101 is NO). When speech input is made (when a result of step S101 is YES), the controller 10 executes the speech recognition processing based on the speech recognition dictionary 25 (step S102), and executes the operation item specifying processing based on the operation item distinguish table 26 next (step S103). The controller 10 then determines whether or not an operation item corresponding to the input voice word has been specified (step S104). If the operation item is specified, the controller 10 executes processing to apply the specified operation item to the image processing device 5 (step S105). The processing for applying the operation item to the image processing device 5 includes processing, such as that to configure setting item corresponding to the operation item selected with voice operation, to update the display screen of the display unit 14 in response to the setting, to start execution of a job, to stop a job during execution, and to update the display screen of the display unit 14 in response to start or stop of job execution. The controller 10 then generates voice operation history information based on the detail of the applied processing (step S106), and updates the voice operation history information 82 stored in the storage device 21 (step S107).

In contrast, if operation item is not specified from the input voice word (when a result of step S104 is NO), the controller 10 executes customization processing for updating the operation item distinguish table 26 (step S108).

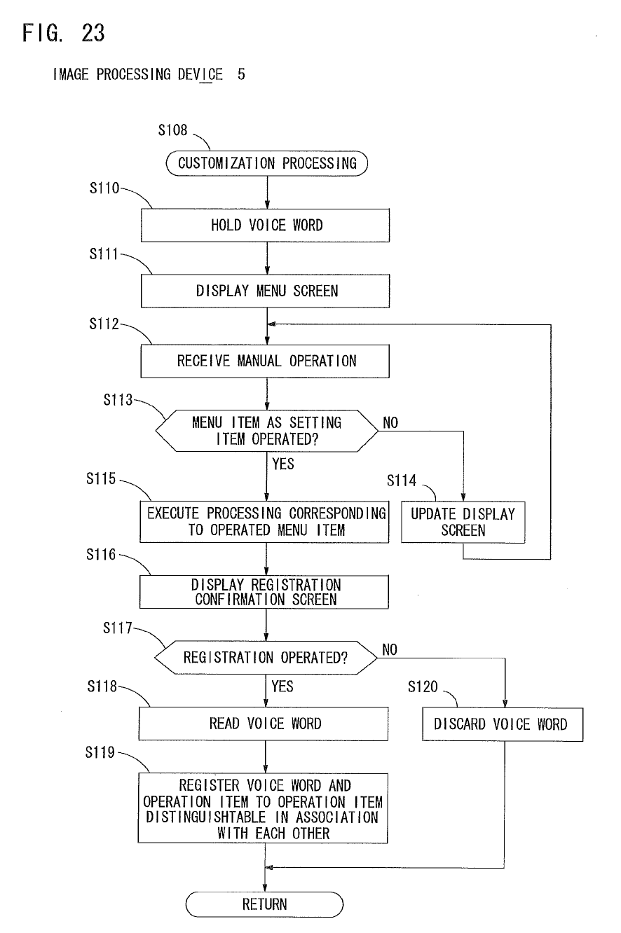

FIG. 23 is a flow diagram explaining an exemplary procedure of the customization processing in detail. As the process moving on to the customization processing, the controller 10 holds therein the voice word recognized in the voice recognition processing temporary (step S110). The controller 10 then displays the menu screen on the display unit 14 (step S111), and receives user's operation made by manual (step S112). After user's operation by manual is made, the controller 10 determines whether or not a menu item as setting item is operated (step S113). While a menu item as setting item is not operated, so a menu item as option item is operated (when a result of step S113 is NO), the controller 10 updates the display screen on the display unit 14 (step S114) in order to display a menu item on one level lower than the selected menu item. The menu item as setting item is operated at last after repeated execution of processing in step S112 to step S114 (when a result of step S113 is YES), the controller 10 applies setting corresponding to the menu item to the image processing device 5 (step S115).

The controller 10 then displays a registration confirmation screen on the display unit 14, and asks whether or not to newly register a combination of the voice word that is hold temporary and the menu item as its setting item of the voice word to the operation item distinguish table 26 (step S116). If a user makes a registration operation with this registration confirmation screen being displayed (when a result of step S117 is YES), the controller 10 reads the voice word hold temporary (step S118). The controller 10 then associates the read voice word and the operation item (the menu item as setting item) and registers in the operation item distinguish table 26 (step S119). Here, the controller 10 registers the combination of the voice word and the operation item in at least one table (such as the user table 55a, 55b or 55c and the shared table 561a 561b, 562a or 562b as shown in FIG. 7) corresponding to the user contained in the customized table 54. If the user does not make a registration operation (when a result of step S117 is NO), the controller 10 discards the voice word temporarily hold (step S120), and completes this processing.

Thus, this customization processing (step S108) allows the previously-input voice word and the operated menu item to be associated and to be registered in the operation item distinguish table 26, while operation of the menu item is made by manual by the user. In the example described above, the voice word is input first, and the menu item to be associated with the voice word is selected with manual operation next. The sequence may be reversed, so for instance, the menu item may be selected first, and the voice word to be associated with the menu item may be input later. However, it is preferable to configure input of a voice word corresponding to operation during the series of manual operations made to the menu screen. Therefore, customization processing may be incorporated in the series of procedures of operation. The processing for associating the voice word with the menu item displayed on the menu screen is explained. It is also allowed to associate the voice word with the push-button key.

Even when the voice word input to the speech input part 16 does not completely match the name of its menu item, the above-described customization processing allows to associate the voice word with the menu item and additionally register in the operation item distinguish table 26. Therefore, a combination of a voice word and an operation item that the user desires is allowed to be registered.

Returning to the flow diagram in FIG. 22, when the voice operation mode is being OFF (when a result of step S100 is NO), the controller 10 executes the regular processing to receive only manual operation (step S109). In the regular processing, only manual operation by the user is received. When manual operation is made, the manual operation history information 81 is updated after processing based on the manual operation.

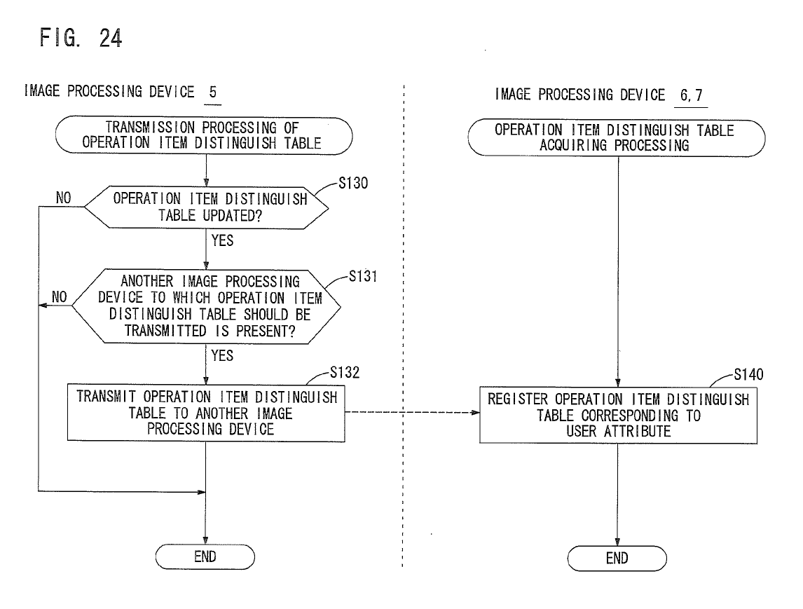

Next, FIG. 24 is a flow diagram explaining an exemplary procedure of a processing to transmit the operation item distinguish table 26 from the image processing device 5 to the image processing devices 6 and 7. In this flow diagram, the transmission processing of operation item distinguish table 26 executed in the image processing device 5 is a processing, for example, repeatedly executed by the controller 10 of the image processing device 5 at a constant period. The controller 10 of the image processing device 5 determines whether or not the operation item distinguish table 26 stored in the storage device 21 is updated (step S130). When the operation item distinguish table 26 is not updated (when a result of step S130 is NO), the processing is completed. When the operation item distinguish table 26 is updated (when a result of step S130 is YES), the controller 10 then checks whether or not another image processing device 6 and/or 7 to which the operation item distinguish table 26 should be transmitted is present in the network 9 (step S131).

In the check processing, for example, whether or not the image processing device in which a user who has an user attribute the same as the one of a user who made the operation of customization of the operation item distinguish table 26 to the image processing device 5 is registered is present among other image processing devices 6 and 7 connected to the network 9 is checked. While another image processing device in which the user who has the same user attribute registered is present, the image processing device is extracted as the target of transmission of the operation item distinguish table 26. By way of example, it is assumed the user A uses the image processing device 5 to customize the operation item distinguish table 26. When the user A is registered in the user information 22 of the image processing device 6 or 7 as a user who is authorized to use the image processing device 6 or 7, the image processing device 6 and/or 7 is extracted as a target of transmission of the operation item distinguish table 26. Even when the user A is not registered in the user information 22 of the image processing device 6 or 7 as a user who is authorized to use the image processing device 6 or 7 but another user whose group is the same as the user A's or another user who shares a workflow with the user A is registered in the user information 22 of the image processing device 6 or 7 as a user who is authorized to use the image processing device 6 or 7, the image processing device 6 and/or 7 is extracted as the target of transmission of the operation item distinguish table 26.

While another image processing device 6 or 7 to which the operation item distinguish table 26 should be transmitted is present (when a result of step S131 is YES), the controller 10 of the image processing device 5 transmits the updated operation item distinguish table 26 to another image processing device 6 or 7 (step S132). In the second preferred embodiment, the entire operation item distinguish table 26 shown in FIG. 7 may be transmitted, but also only the customized table 54 may be transmitted. While another image processing device to which the operation item distinguish table 26 should be transmitted is not present (when a result of step S131 is NO), the processing is completed here.

After receiving the operation item distinguish table 26 from the image processing device 5 through the network 9, the image processing device 6 and/or 7 executes a processing to register the received operation item distinguish table 26 corresponding to user attribute (step S140). In this processing, information contained in the received table is registered in the operation item distinguish table 26 stored in the respective storage device 21 of the image processing device 6 and/or 7. Here, information contained in the received table is registered in both or either of the user table DB 55 and/or the shared table 56.

According to the processing described above, the operation item distinguish table 26 updated in the image processing device 5 is transmitted to another image processing device 6 and/or 7 through the network 9. In the image processing device 6 and/or 7, a combination of the voice word and the operation item contained in the operation item distinguish table 26 received from the image processing device 5 may be used for voice operation. So, in the second preferred embodiment, for example, it is assumed “REVERSE” is registered as a voice word for setting the menu item “negative-positive reverse” while the image processing device 5 is used by the user A. In this case, as inputting the voice word “REVERSE” not only for the use of the image processing device 5 but also for the use of the image processing device 6 and/or 7, the menu item “negative-positive reverse” may be specified as the operation item corresponding to the voice word.

Therefore, as well as the first preferred embodiment, operability of the user who uses the plurality of image processing devices is improved in the second preferred embodiment. Furthermore, according to the second preferred embodiment, as one or more users who belong to the same group use different image processing devices, or one or more users registered with the particular workflow use different image processing devices, at least one user of those one or more users registers a combination of a voice word and an operation item to one of the image processing devices. As a result, the combination is applied to other image processing devices as well. So, even when each user uses the different image processing device, he or she may make the same voice operation with the shared voice word.

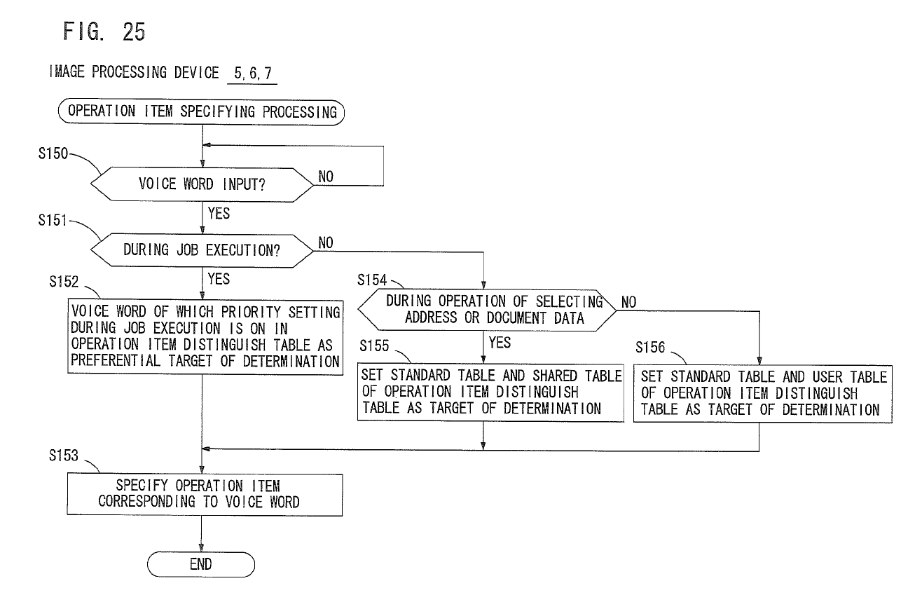

Next, FIG. 25 is a flow diagram explaining an exemplary procedure of a process to specify an operation item corresponding to the voice word input in the image processing device 5, 6 or 7. This processing corresponds to the detailed procedure of the operation item specifying processing (step S13, step S103) shown in FIG. 12 and FIG. 22. As inputting a voice word (when a result of step S150 is YES), the controller 10 of the image processing device 5, 6 or 7 determines whether or not the present status of the image processing device is during job execution (step S151). If the status is during job execution (when a result of step S151 is YES), the controller 10 sets the voice word of which the priority setting during job execution is ON in the operation item distinguish table 26 (see FIG. 8) as a preferential target of determination (step S152). The voice word of which the priority setting during job execution is ON in the operation item distinguish table 26 becomes a preferential target of determination during the job execution. So, for instance, when the voice word “STOP” is said by the user, the execution of job may be stopped immediately.

If the status is not during job execution (when a result of step S151 is NO), the controller 10 determines whether the present status of the image processing device is during operation of selecting address for, such as “scan to” function or fax transmission function, or during operation of selecting document data saved in the storage device 21 (step S154). When the present status is during operation of selecting either ones (when a result of step S154 is YES), the controller 10 sets the standard table 51 and the shared table DB 56 of the operation item distinguish table 26 (see FIG. 7) as the target of determination (step S155). While address or document data is selected by the user, the shared table 561a, 561b, 562a or 562b included in the standard table 51 and the shared table DB 56 of the operation item distinguish table 26 are to be set as the target of determination. So, the operation item corresponding to the input voice word may be specified from much more voice words. As a result, accuracy for specifying operation item is improved.

Furthermore, if the present status is not even during operation of selecting address or document data (when a result of step S154 is NO), the controller 10 sets the standard table 51 and the user table DB 55 (see FIG. 7) of the operation item distinguish table 26 as the target of determination (step S156). In this case, it is considered that operation of selecting a menu item for setting variety of functions of the image processing device is being made to the operational panel 13 by the user. The standard table 51 and the user tables 55a, 55b or 55c in which only the voice word that the user registered in his own are set as the target of determination. Therefore, the number of the voice word to be the target of determination may be reduced, resulting in improvement in efficiency for specifying operation item corresponding to the voice word.

The controller 10 then specifies the operation item corresponding to the input voice word based on the target of determination set in one of step S152, step S155 or step S156 (step S153).

Thus, for specifying the operation item corresponding to the voice word input in the image processing device 5, 6 or 7, the target of determination in the operation item distinguish table 26 may be switched corresponding to the present status of the image processing device by executing the above-described processing. Especially, in the above-described processing, only voice word as to job control is set as the preferential target of determination during job execution. So, for instance, if a voice word to stop a job during execution is said by the user, the operation item (stop of the job) corresponding to the voice word is allowed to be specified rapidly, and the job is stopped immediately. Moreover, during the operation of selecting address or document data made by the user, the shared table DB 56 generated with registration of one or more users becomes the target of determination besides the standard table 51. For address or document data to be selected, address or document data corresponding to the voice word may be selected properly from a large number of the targets of determination.

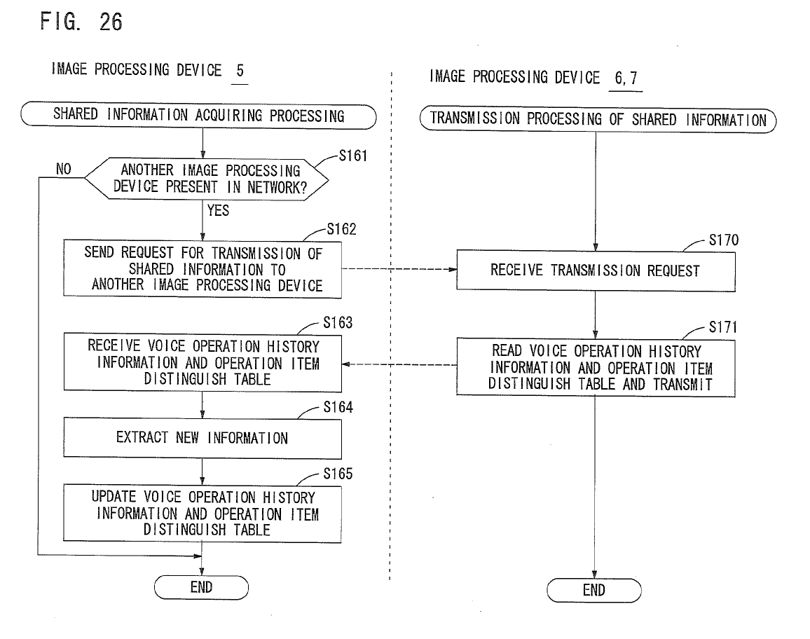

Next, another procedure of a processing executed by the image processing device 5 for acquiring the voice operation history information 82 or the operation item distinguish table 26 from another image processing device 6 or 7. FIG. 26 is a flow diagram explaining the procedure of a processing executed by the image processing device 5 for acquiring shared information, such as the voice operation history information 82 and the operation item distinguish table 26 by sending a request for transmission of the shared information to another image processing device 6 or 7. This processing is, for example, executed in the image processing device 5 several times at a constant period. As starting this processing, the controller 10 of the image processing device 5 determines whether or not another image processing device 6 and/or 7 is present in the network 9 (step S161). When another image processing device 6 and/or 7 is not present (when a result of step S161 is NO), the processing is completed.

When another image processing device 6 and/or 7 is present in the network 9 (when a result of step S161 is YES), the controller 10 of the image processing device 5 sends a request for transmission of the shared information such as the voice operation history information 82 or the operation item distinguish table 26 to the image processing device 6 and/or 7 (step S162). The request for transmission is received by the image processing device 6 and/or 7.

As receiving the request for transmission by the image processing device 5 (step S170), the controller 10 of each of the image processing devices 6 and 7 reads the voice operation history information 82 and the operation item distinguish table 26 from the respective storage device 21, and transmits to the image processing device 5 (step S171). The shared information transmitted here is received by the image processing device 5.

The controller 10 of the image processing device 5 receives the respective voice operation history information 82 and the operation item distinguish table 26 transmitted by the image processing device 6 and/or 7 (step S163). In the image processing device 5, new information that has not been registered with the image processing device 5 at the time of receipt is extracted from the received respective voice operation history information 82 and the operation item distinguish table 26 (step S164). Only the extracted new information is then additionally registered in the voice operation history information 82 and the operation item distinguish table 26 stored in the storage device 21, and the shared information is updated (step S165). Thus, the processing is completed.

According to the flow diagram in FIG. 26, the image processing device 5 sends the request for transmission to another image processing device 6 and/or 7, thereby acquiring shared information of the voice operation history information 82 and the operation item distinguish table 26 from another image processing device 6 and/or 7. In the case of this procedure of the processing, for example, it is assumed the power of the image processing device 5 is OFF and the respective shared information transmitted from another image processing device 6 and/or 7 cannot be received when the respective shared information is updated in another image processing device 6 and/or 7. Even in such case, the respective shared information may be acquired from another image processing device 6 and/or 7 after the image processing device 5 is turned on.

As described above, information, such as the operation history information or the operation item distinguish table, updated in the image processing device with the voice operation function is transmitted from the image processing device with the voice operation function to another image processing device. Therefore, the information may also be used in another image processing device. So, the information, such as the operation history information or the operation item distinguish table may be shared by the plurality of image processing devices, resulting in improvement in operability for using the image processing device.

### MODIFICATIONS

While the preferred embodiments of the present invention have been described above, the present invention is not limited to these preferred embodiments. Various modifications besides above-described preferred embodiments may be applied to the present invention.

By way of example, in the preferred embodiments described above, the shared information, such as the voice operation history information 82 or the operation item distinguish table 26 is directly transmitted from one image processing device to another image processing device as an exemplary way of transmission from one image processing device to another image processing device. However, the way is not limited to this case. More specifically, the shared information may alternatively be transmitted to another image processing device via a relay server such as a shared information management server, for example, for transmission of the shared information such as the voice operation history information 82 or the operation item distinguish table 26 from one image processing device to another image processing device.

In the preferred embodiments described above, the image processing device is shown to be a device with several functions including a copy function, a print function, a scan function and a FAX function. However, the image processing device is not necessarily a device with several functions. The image processing device may be a device has at least one of the above-described functions.

In the preferred embodiments described above, the speech recognition dictionary 25 that the speech recognition part 33 refers to and the operation item distinguish table 26 that the operation item specifying part 34 refers to are explained separately. However, a table into which the speech recognition dictionary and the operation item distinguish table integrated may be referred to by the speech input processing part 32.

While the invention has been shown and described in detail, the foregoing description is in all aspects illustrative and not restrictive. It is therefore understood that numerous modifications and variations can be devised without departing from the scope of the invention.

What is claimed is:

1. An image processing device allowed to be connected to a network, comprising:
an operational panel for displaying a menu screen and receiving a manual operation to said menu screen;
a speech input part for inputting speech;
an operation item specifying part for specifying an operation item to be a target of operation among menu items displayed on said menu screen based on a voice word input through said speech input part;
a voice operation control part for executing a processing corresponding to said specified operation item;
a history information generation part for generating a voice operation history information in which the voice word input through said speech input part and the operation item specified by said operation item specifying part are associated when the processing corresponding to said specified operation item is executed; and
a transmission part for transmitting said voice operation history information generated by said history information generation part to another image processing device through the network.

2. The image processing device according to claim 1, wherein
said operation item specifying part specifies said operation item even when the voice word input through said speech input part does not match a name of the menu item that is said operation item, and
said history information generation part generates the voice operation history information in which the voice word input through said speech input part and the menu item that is the operation item specified by said operation item specifying part are associated.

3. The image processing device according to claim 1, wherein
said menu items have a hierarchy structure by which the menu item is selected one by one gradually with manual operation, and
said operational panel displays the voice word contained in said voice operation history information on the menu screen on which the menu item on higher level in the hierarchy structure including the menu item operated with voice operation is displayed.

4. The image processing device according to claim 1, further comprising:
an acquisition part for acquiring the voice operation history information generated by another image processing device through the network, wherein
the voice operation history information acquired by said acquisition part is incorporated into said voice operation history information generated by said history information generation part.

5. An image processing device allowed to be connected to a network, comprising:
an operational panel for displaying a menu screen and receiving manual operation on said menu screen;
a speech input part for inputting speech;
a storage part for storing an operation item distinguish table in which a voice word input through said speech input part and an operation item to be a target of operation among menu items displayed on said menu screen are associated;
an operation item specifying part for specifying said operation item associated with the voice word input through said speech input part based on said operation item distinguish table;
a voice operation control part for executing a processing corresponding to said operation item specified by said operation item specifying part;
a table customization part for associating the voice word that a user desires with the menu item that is the operation item, and additionally registering in said operation item distinguish table, thereby updating said operation item distinguish table; and
a transmission part for transmitting said operation item distinguish table updated by said table customization part to another image processing device through the network.

6. The image processing device according to claim 5, wherein
when the voice word input through said speech input part does not match the name of one of the menu items while said one of the menu items on said menu screen is selected with manual operation made to said operational panel, said table customization part additionally registers said selected menu item as said operation item associated with said input voice word in said operation item distinguish table.

7. The image processing device according to claim 5, wherein
when the voice word the user desires is associated with the menu item that is the operation item and additionally registered in said operation item distinguish table, said table customization part additionally registers in both of a user table for the user and a shared table shared by one or more users.

8. The image processing device according to claim 5, wherein
said operation item distinguish table includes a setting whether or not to determine in preference corresponding to the status of job execution defined for the voice word input through said speech input part, and
said operation item specifying part determines in preference the voice word for which the setting to determine in preference is made corresponding to the status of job execution, thereby specifying the operation item.

9. The image processing device according to claim 5, further comprising:
an acquisition part for acquiring the operation item distinguish table held by another image processing device through the network, wherein
the operation item distinguish table acquired by said acquisition part is incorporated into said operation item distinguish table updated by said table customization part.

10. An image processing device allowed to be connected to a network, comprising:
an operational panel for displaying a menu screen and receiving a manual operation on said menu screen;
an acquisition part for acquiring a voice operation history information though the network from another image processing device with a voice operation function for specifying an operation item to be a target of operation based on a voice word and receiving voice operation corresponding to said specified operation item;
a voice operation history applying part for associating a menu item displayed on said menu screen and the voice word based on said voice operation history information acquired by said acquisition part; and
a display control part for displaying the voice word associated by said voice operation history applying part on said operational panel.

11. The image processing device according to claim 10, wherein
the menu items displayed on said menu screen have a hierarchy structure by which the menu item is selected one by one gradually with manual operation, and
said display control part displays the voice word in association with the menu item on the highest level displayed on said menu screen on said operational panel.

12. The image processing device according to claim 10, wherein
said voice operation history applying part associates the voice word only when the menu item to be associated with the voice word is available in said image processing device.

13. A method for first image processing device with a voice operation function and second image processing device different from said first image processing device to share a voice operation history information in said first image processing device through a network,
the method comprising the steps performed in said first image processing device of:
(a) inputting a voice word;
(b) specifying an operation item to be a target of operation among menu items displayed on a menu screen of an operational panel based on the input voice word;
(c) executing a processing corresponding to said specified operation item;
(d) generating a voice operation history information in which said voice word and said operation item are associated when the processing corresponding to said specified operation item is executed; and
(e) transmitting said voice operation history information to said second image processing device through the network,
the method comprising the steps performed in said second image processing device of:
(f) acquiring said voice operation history information transmitted from said first image processing device through the network;
(g) associating said voice word contained in said voice operation history information with the menu item displayed on a menu screen of an operational panel based on said acquired voice operation history information; and
(h) displaying said voice word associated with said menu item on the operational panel.

14. A method for first and second image processing devices each of that is with a voice operation function for specifying an operation item to be a target of operation based on a voice word and receiving voice operation corresponding to said specified operation item, to be connected to each other through a network to share an operation item distinguish table to be used for specifying the operation item from the voice word, the method comprising the steps of:
(a) associating the voice word that a user desires and the menu item that is the operation item, and additionally registering in said operation item distinguish table, thereby executing customization of said operation item distinguish table in said first image processing device;
(b) transmitting said customized operation item distinguish table from said first image processing device to said second image processing device when customization of said operation item distinguish table is executed; and
(c) using said operation item distinguish table received from said first image processing device for specifying the operation item based on the voice word input in said second image processing device.
